(19) United States
(12) Patent Application Publication
(10) Pub. No.: US 2022/0124475 A1
(43) Pub. Date: Apr. 21, 2022

(54) METHOD AND APPARATUS FOR RELAYING SYSTEM INFORMATION ON SIDELINK IN WIRELESS COMMUNICATION SYSTEM

(71) Applicant: Samsung Electronics Co., Ltd., Suwon-si (KR)

(72) Inventors: Hyunjeong KANG, Suwon-si (KR); Anil AGIWAL, Suwon-si (KR)

(21) Appl. No.: 17/506,962

(22) Filed: Oct. 21, 2021

(30) Foreign Application Priority Data
Oct. 21, 2020 (KR) 10-2020-0136924
Apr. 1, 2021 (KR) 10-2021-0042740
Aug. 3, 2021 (KR) 10-2021-0102059

(51) Int. Cl. H04W 8/00; H04W 72/12

(52) U.S. Cl. CPC H04W 8/005; H04W 88/04; H04W 72/1278

(57) ABSTRACT

The disclosure relates to a communication method and a system for converging a 5th-Generation (5G) communication system for supporting higher data rates beyond a 4th-Generation (4G) system with a technology for Internet of things (IoT). The disclosure may be applied to intelligent services based on the 5G communication technology and the IoT-related technology, such as a smart home, a smart building, a smart city, a smart car, a connected car, health care, digital education, smart retail, security and safety services. A sidelink relay method and a device for relaying a system information message and a paging message in a wireless communication system are provided.

### CROSS-REFERENCE TO RELATED APPLICATION(S)

This application is based on and claims priority under 35 U.S.C. § 119(a) of a Korean patent application number 10-2020-0136924, filed on Oct. 21, 2020, in the Korean Intellectual Property Office, of a Korean patent application number 10-2021-0042740, filed on Apr. 1, 2021, in the Korean Intellectual Property Office, and of a Korean patent application number 10-2021-0102059, filed on Aug. 3, 2021, in the Korean Intellectual Property Office, the disclosure of each of which is incorporated by reference herein in its entirety.

### BACKGROUND

### 1. Field

The disclosure relates to a wireless communication system. More particularly, the disclosure relates to a method and an apparatus for a relay terminal to relay a system information message and a paging message based on a sidelink in a wireless communication system.

### 2. Description of Related Art

To meet the demand for wireless data traffic having increased since deployment of 4th generation (4G) communication systems, efforts have been made to develop an improved 5th generation (5G) or pre-5G communication system. Therefore, the 5G or pre-5G communication system is also called a ‘Beyond 4G Network’ or a ‘Post long term evolution (LTE) System’.

The 5G communication system is considered to be implemented in extremely high frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques have been discussed and adopted in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

Besides, in the 5G system, hybrid frequency shift keying (FSK) and quadrature amplitude modulation (QAM) frequency quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In the 5G system, support for various services is being considered compared to the existing 4G system. For example, as representative services, there are an enhanced mobile broad band (eMBB) service, an ultra-reliable and low latency communication (URLLC) service, a massive machine type communication (mMTC) service, an evolved multimedia broadcast/multicast service (eMBMS) service, and the like. In addition, a system providing the URLLC service may be referred to as a URLLC system, and a system providing the eMBB service may be referred to as an eMBB system. In addition, the terms ‘service’ and ‘system’ may be used interchangeably.

Among them, the URLLC service, which is a service newly considered in the 5G system unlike the existing 4G system, requires ultra-high reliability (e.g., about a packet error rate of 10-5) and low latency (e.g., about 0.5 msec) compared to other services. In order to meet these strict requirements, the URLLC service may need to apply a shorter transmission time interval (TTI) than the eMBB service, and various operating schemes using this are being considered.

Meanwhile, the Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as detection technology, wired/wireless communication and network infrastructure, service interface technology, and security technology have been required for IoT implementation, a sensor network, a machine-to-machine (M2M) communication, machine type communication (MTC), and so forth have been recently researched.

Such an IoT environment may provide intelligent Internet technology services that create a new value to human life by collecting and analyzing data generated among connected things. The IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply the 5G communication system to the IoT network. For example, technologies, such as a sensor network, machine type communication (MTC), and machine-to-machine (M2M) communication are being implemented based on 5G communication technologies, such as beamforming, MIMO, and an array antenna. The use of a cloud radio access network (cloud RAN) for big data processing technology is one example of convergence between the 5G technology and the IoT technology.

In addition, device-to-device direct communication (also referred to as sidelink communication) using a 5G communication system is being studied. The sidelink communication is expected to be applied to, for example, vehicle-to-everything (hereinafter ‘V2X’), a public safety network, and the like and thereby provide various services to users.

More particularly, there is a need for a method of utilizing a sidelink relay capable of supporting service coverage expansion, data transmission reliability increase, and device power consumption reduction.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for a sidelink relay to relay a system information message and a paging message to a terminal in a wireless communication system.

The technical issues to be addressed in the disclosure are not limited to the above-mentioned technical problems, and those of ordinary skill in the art to which the disclosure pertains will clearly understand, from the following description, other technical problems not mentioned herein.

Additional aspects will be set forth in part in the description which follows and, in part, will be apparent from the description, or may be learned by practice of the presented embodiments.

In accordance with an aspect of the disclosure, a method performed by a first terminal in a wireless communication system is provided. The method includes receiving, from a second terminal via a sidelink, a system information request message, and transmitting, to the second terminal via the sidelink, a message including system information.

In some examples, wherein the system information request message includes at least one system information block (SIB) type.

In some examples, wherein the system information request message is a message transmitted in a PC5 radio resource control (RRC) unicast connection.

In some examples, wherein the system information request message is indicated as at least one or a combination of a system information block (SIB) bitmap or a list of SIB indexes.

In some examples, further comprising: collecting a plurality of system information request messages in case that the first terminal receives the plurality of system information request messages.

In accordance with another aspect of the disclosure, a method performed by a second terminal in a wireless communication system is provided. The method includes transmitting, to a first terminal via a sidelink, a system information request message, and receiving, from the first terminal via the sidelink, a message including system information.

In accordance with another aspect of the disclosure, a first terminal in a wireless communication system is provided. The first terminal includes a transceiver capable of transmitting and receiving at least one signal, and at least one processor coupled to the transceiver, wherein the at least one processor is configured to receive, from a second terminal via a sidelink, a system information request message, and transmit, to the second terminal via the sidelink, a message including system information.

In accordance with another aspect of the disclosure, a second terminal in a wireless communication system is provided. The second terminal includes a transceiver capable of transmitting and receiving at least one signal, and at least one processor coupled to the transceiver, wherein the at least one processor is configured to transmit, to a first terminal via a sidelink, a system information request message, and receive, from the first terminal via the sidelink, a message including system information.

According to an embodiment of the disclosure, a method for a terminal to receive a system information message through a sidelink relay in a wireless communication system may include, at the terminal, transmitting a message requesting the system information message to the sidelink relay, and acquiring the system information message relayed through the sidelink relay. The method may include, at the sidelink relay, receiving the message requesting the system information message from the terminal, acquiring a system information message corresponding to the sidelink relay by monitoring a system information message transmitted by a base station, acquiring the system information message requested by the terminal, and transmitting the system information message requested by the terminal to the terminal. The method may include, at the base station, receiving a message requesting system information messages of the sidelink relay and the terminal from the sidelink relay, and transmitting the system information messages corresponding to the sidelink relay and the terminal to the sidelink relay.

According to an embodiment of the disclosure, a method for a terminal to receive a paging message through a sidelink relay in a wireless communication system may include, at the sidelink relay, acquiring paging scheduling configuration information of the terminal through a base station, acquiring a paging corresponding to the terminal by monitoring a paging message transmitted by the base station, and transmitting a paging message to the terminal. The method may include, at the terminal, requesting the sidelink relay to transmit the paging message, and receiving the paging message from the sidelink relay. The method may include, at the base station, providing the paging scheduling configuration information of the terminal to the sidelink relay, and transmitting a paging message including a paging corresponding to the sidelink relay or the terminal.

According to an embodiment of the disclosure, it is possible to provide an apparatus and method capable of effectively providing a service and expanding a service coverage in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a diagram illustrating a wireless communication system according to an embodiment of the disclosure;

FIG. 1B is a diagram illustrating a wireless communication system according to an embodiment of the disclosure;

FIG. 2 is a diagram illustrating a configuration of a base station in a wireless communication system according to an embodiment of the disclosure;

FIG. 3 is a diagram illustrating a configuration of a user equipment (UE) in a wireless communication system according to an embodiment of the disclosure;

FIG. 4 is a diagram illustrating a configuration of a communication unit in a wireless communication system according to an embodiment of the disclosure;

FIG. 5 is a diagram illustrating a structure of a time-frequency resource of a wireless communication system according to an embodiment of the disclosure;

FIG. 6A is a diagram illustrating a signal flow of acquiring a system information message and a paging message at a UE according to an embodiment of the disclosure;

FIG. 6B is a diagram illustrating a signal flow of acquiring a system information message and a paging message at a UE according to an embodiment of the disclosure;

FIG. 6C is a diagram illustrating a signal flow of acquiring a system information message and a paging message at a UE according to an embodiment of the disclosure;

FIG. 7A is a diagram illustrating a signal flow of acquiring a system information message at a UE according to an embodiment of the disclosure;

FIG. 7B is a diagram illustrating a signal flow of acquiring a system information message at a UE according to an embodiment of the disclosure;

FIG. 7C is a diagram illustrating a signal flow of acquiring a system information message at a UE according to an embodiment of the disclosure;

FIG. 7D is a diagram illustrating a signal flow of acquiring a system information message at a UE according to an embodiment of the disclosure;

FIG. 8A is a diagram illustrating a signal flow of acquiring a system information message at a UE according to an embodiment of the disclosure;

FIG. 8B is a diagram illustrating a signal flow of acquiring a system information message at a UE according to an embodiment of the disclosure;

FIG. 8C is a diagram illustrating a signal flow of acquiring a system information message at a UE according to an embodiment of the disclosure;

FIG. 9A is a diagram illustrating a scheduling structure of transmitting and receiving a system information message in a sidelink according to an embodiment of the disclosure;

FIG. 9B is a diagram illustrating a scheduling structure of transmitting and receiving a system information message in a sidelink according to an embodiment of the disclosure;

FIG. 10 is a diagram illustrating a signal flow of establishing a PC5 radio resource control (RRC) connection to acquire a system information message at a UE according to an embodiment of the disclosure;

FIG. 11A is a diagram illustrating a signal flow of acquiring a paging message at a UE according to an embodiment of the disclosure;

FIG. 11B is a diagram illustrating a signal flow of acquiring a paging message at a UE according to an embodiment of the disclosure; and

FIG. 11C is a diagram illustrating a signal flow of acquiring a paging message at a UE according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments of the disclosure, descriptions of technical contents that are well known in the technical field to which the disclosure pertains and are not directly related to the disclosure will be omitted. This is to more clearly convey the subject matter of the disclosure without obscuring it by omitting unnecessary description.

For the same reason, some elements are exaggerated, omitted, or schematically illustrated in the accompanying drawings. In addition, the depicted size of each element does not fully reflect the actual size. In the drawings, the same or corresponding elements are assigned the same reference numerals.

The advantages and features of the disclosure and the manner of achieving them will become apparent through embodiments described below with reference to the accompanying drawings. The disclosure may be, however, embodied in many different forms and should not be construed as being limited to the embodiments set forth herein. Rather, these embodiments are provided so that the disclosure will be thorough and complete and will fully convey the scope of the disclosure to those skilled in the art. The disclosure is only defined by the scope of the appended claims. Throughout the specification, the same reference numerals refer to the same constitutional elements.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operations to be performed on the computer or other programmable apparatus to produce a computer implemented process such that the instructions that are executed on the computer or other programmable apparatus provide operations for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. A “unit” may be constructed either to be stored in an addressable storage medium or to execute one or more processors. Therefore, a “unit” includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and units may be combined into those of a smaller number of elements and units or separated into those of a larger number of elements and units. In addition, the elements and units may be implemented to operate one or more central processing units (CPUs) within a device or a secure multimedia card.

Embodiments of the disclosure will be described mainly based on a radio access network, i.e., New RAN (NR), and a core network, i.e., a packet core (a 5G system, a 5G core network, or a next generation (NG) core), in the 5G mobile communication standard specified by the mobile communication standard standardization organization, 3GPP. However, the disclosure can be also applied to other communication systems having a similar technical background with only slight modifications without significantly departing from the scope of the disclosure, which will be understood well by a person skilled in the art of the disclosure.

In the 5G system, in order to support network automation, a network data collection and analysis function (NWDAF), which is a network function that analyzes and provides data collected from the 5G network, may be defined. The NWDAF may collect/store/analyze information from the 5G network and provide the analysis results to unspecified network functions (NFs), each of which can use the analysis results independently.

For convenience of description below, some terms and names defined in standards of the 3rd generation partnership project long term evolution (3GPP) (e.g., standards of 5G, NR, LTE, or similar systems) may be used. However, the disclosure is not limited by such terms and names and may be equally applied to systems conforming to other standards.

The disclosure relates to a method and an apparatus for a user equipment performing sidelink-based data transmission/reception in a wireless communication system to acquire a system information message or a paging message transmitted by a base station through a sidelink relay. The disclosure provides a method and an apparatus for user equipment performing data transmission/reception based on sidelink unicast, sidelink groupcast, or sidelink broadcast in a wireless communication system to acquire a system information message or a paging message transmitted by a base station through a sidelink relay.

Specifically, the disclosure provides a solution in which a user equipment transmits a system information request message for requesting a system information message to a sidelink relay and the sidelink relay monitors and acquires from the base station the system information message requested by the user equipment and transmits the acquired system information message to the user equipment. In addition, the disclosure provides a solution in which a sidelink relay acquires paging configuration information of a user equipment from a base station or the user equipment, monitors and acquires a paging message of the user equipment from the base station, and transmits the acquired paging message to the user equipment. According to embodiments of the disclosure, by enabling the user equipment to perform an operation of acquiring the system information message or paging message through the sidelink relay, it is possible to expand the service coverage, increase the reliability of data transmission and reception, and minimize the battery usage of the user equipment.

Specifically, according to an embodiment of the disclosure, a method for a user equipment to acquire a system information message through a sidelink relay in a wireless communication system may include, at the user equipment, transmitting a system information request message to the sidelink relay, monitoring and acquiring the system information message transmitted by the sidelink relay. The method may include, at the sidelink relay, receiving the system information request message from the user equipment, acquiring the system information message requested by the user equipment by monitoring a system information message transmitted by a base station, and transmitting the system information message to the user equipment. The method may include, at the base station, acquiring the system information request message of the user equipment through the sidelink relay, and transmitting system information messages requested by the sidelink relay and the user equipment. According to an embodiment of the disclosure, a method for a user equipment to acquire a paging message through a sidelink relay in a wireless communication system may include, at the sidelink relay, acquiring paging configuration of the user equipment from the user equipment or a base station, acquiring paging information corresponding to the user equipment by monitoring a paging message transmitted by the base station, and transmitting the paging message to the user equipment. The method may include, at the user equipment, requesting the sidelink relay to transmit the paging message, and monitoring the paging message transmitted by the sidelink relay. The method may include, at the base station, transmitting the paging configuration of the user equipment to the sidelink relay, and transmitting a paging message including paging information of the sidelink relay and the user equipment.

In the following description, terms that refer to signals, terms that refer to channels, terms that refer to control information, terms that refer to network entities, and terms that refer to components of devices are for convenience of description. Therefore, the disclosure is not limited to such terms, which may be replaced with other terms referring to objects having equivalent technical meanings.

In the disclosure, the base station refers to an entity that performs resource allocation of the user equipment, and may be at least one of a gNode B, an eNode B, a Node B, a base station (BS), a radio access unit, a base station controller, or a node on a network. In addition, the user equipment (UE) may include a terminal, a mobile station (MS), a cellular phone, a smart phone, a computer, or a multimedia system capable of performing a communication function. However, this is merely exemplary, and the base station and the user equipment are not limited to the above examples. In the disclosure, an eNB may be used interchangeably with a gNB for convenience of description. For example, the base station described as the eNB may represent the gNB. In the disclosure, the term user equipment may refer to a mobile phone, NB-IoT devices, sensors, or various types of wireless communication devices.

In the disclosure, a physical channel and a signal may be used interchangeably with data or a control signal. For example, a physical downlink shared channel (PDSCH) is a term that refers to a physical channel through which data is transmitted, but the PDSCH may also be used to refer to data. For example, in the disclosure, an expression “transmitting a physical channel” may be interpreted equivalently to an expression “transmitting data or a signal through a physical channel”.

In the disclosure, higher signaling refers to a method of transmitting a signal from a base station to a user equipment through a downlink data channel of a physical layer, or from a user equipment to a base station through an uplink data channel of a physical layer. The higher signaling may be understood as radio resource control (RRC) signaling or media access control (MAC) control element (CE).

In the disclosure, an expression of ‘greater than’ or ‘smaller than’ is used so as to determine whether a specific condition is satisfied or fulfilled, but this does not exclude an expression of ‘equal to or greater than’ or ‘equal to or smaller than’ For example, a condition expressed as ‘greater than’ may be replaced with a condition expressed as ‘equal to or greater than’, a condition expressed as ‘smaller than’ may be replaced with a condition expressed as ‘equal to or smaller than’, and vice versa.

In the disclosure, although embodiments are described using terms defined in some communication standards (e.g., 3GPP), this is only for description. The embodiments of the disclosure may also be applied to other communication systems through simple modification.

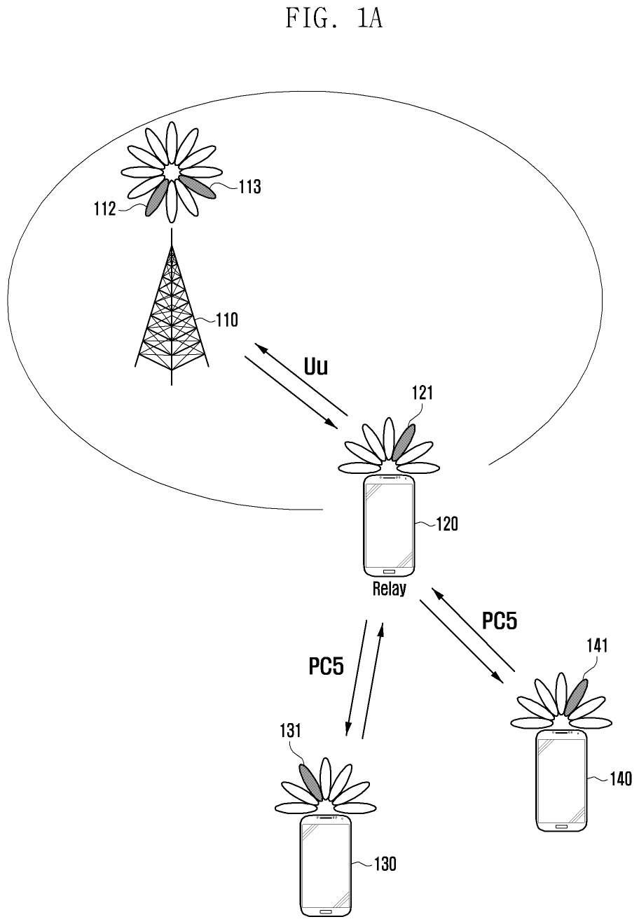

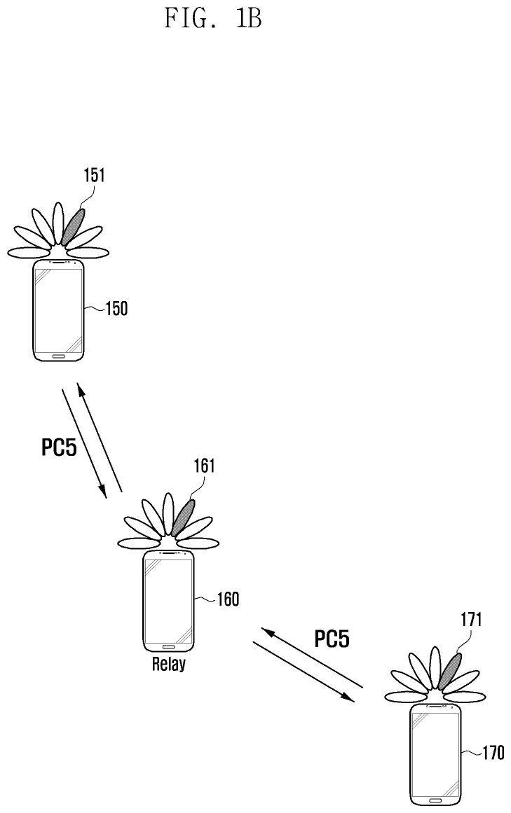

FIG. 1A is a diagram illustrating a wireless communication system according to an embodiment of the disclosure.

Referring to FIG. 1A, it illustrates, as parts of nodes using a wireless channel in the wireless communication system, a base station 110, UEs 130 and 140, and a sidelink relay 120 capable of relaying data transmission/reception between the base station and the UE. The sidelink relay corresponds to a UE-to-network (U2N) relay. Although FIG. 1A shows only one base station, other base stations identical with or similar to the base station 110 may be further included.

The base station 110 is a network infrastructure that provides a radio access to the UEs 130 and 140 and the relay 120. The base station 110 has coverage defined as a certain geographic area based on a signal transmittable distance. The base station 110 may be referred to as ‘access point (AP)’, ‘eNodeB (eNB)’, ‘5th generation (5G) node’, ‘next generation nodeB (gNB)’, ‘wireless point’, ‘transmission/reception point (TRP)’, or any other term having an equivalent technical meaning

The relay 120 is a device used by a user or a network infrastructure and may communicate with the base station 110 through a wireless channel A link from the base station 110 to the relay 120 may be referred to as a downlink (DL), and a link from the relay 120 to the base station 110 may be referred to as an uplink (UL). The base station 110 and the relay 120 may be connected through a Uu interface. The uplink (UL) refers to a radio link through which the relay 120 transmits data or a control signal to the base station 110, and the downlink (DL) refers to a radio link through which the base station 110 transmits data or a control signal to the relay 120.

The relay 120 may communicate with the UE 130 and the UE 140 through wireless channels. Each of a link between the relay 120 and the UE 130 and a link between the relay 120 and the UE 140 is referred to as a sidelink, and the sidelink may also be referred to as a PC5 interface.

Each of the UEs 130 and 140 is a device used by a user and may communicate with the base station 110 through a wireless channel or communicate with a network through a wireless channel with the relay 120. However, in the disclosure, only a case where the UEs 130 and 140 perform communication through a wireless channel with the relay 120 is illustrated. At least one of the UEs 130 and 140 may be operated without the user's involvement. For example, at least one of the UEs 130 and 140 is a device of performing machine type communication (MTC) and may not be carried by the user. Each of the UEs 130 and 140 may be referred to as ‘user equipment (UE)’, ‘terminal’, ‘mobile station’, ‘subscriber station’, ‘remote terminal’, ‘wireless terminal’, ‘user device’, or any other term having an equivalent technical meaning

FIG. 1B is a diagram illustrating a wireless communication system according to an embodiment of the disclosure.

Referring to FIG. 1B, it illustrates the wireless communication system including, as parts of nodes using a wireless channel, UEs 150 and 170 and a sidelink relay 160 capable of relaying data transmission/reception between UEs. The sidelink relay 160 corresponds to a UE-to-UE (U2U) relay.

The relay 160 may communicate with the UE 150 and the UE 170 through wireless channels. Each of a link between the relay 160 and the UE 150 and a link between the relay 160 and the UE 170 is referred to as a sidelink, and the sidelink may also be referred to as a PC5 interface.

Each of the UEs 150 and 170 is a device used by a user and may perform direct communication with a counterpart UE through a wireless channel or perform communication through a wireless channel with the relay 160. Each of a link between the UEs 150 and 170, a link between the UE 150 and the relay 160, and a link between the UE 170 and the relay 160 is referred to as a sidelink, and the sidelink may also be referred to as a PC5 interface.

At least one of the UEs 150 and 170 may be operated without the user's involvement. For example, at least one of the UEs 150 and 170 is a device of performing machine type communication (MTC) and may not be carried by the user. Each of the UEs 150 and 170 may be referred to as ‘user equipment (UE)’, ‘terminal’, ‘mobile station’, ‘subscriber station’, ‘remote terminal’, ‘wireless terminal’, ‘user device’, or any other term having an equivalent technical meaning

In the following description, the uplink or downlink may be used interchangeably with the Uu interface, and the sidelink may be used interchangeably with the PC-5 interface.

The base station 110, the relays 120 and 160, and the UEs 130, 140, 150, and 170 shown in FIGS. 1A and 1B are capable of transmitting and receiving wireless signals in a millimeter wave (mmWave) band (e.g., 28 GHz, 30 GHz, 38 GHz, or 60 GHz). In addition, the base station 110, the relays 120 and 160, and the UEs 130, 140, 150, and 170 may perform beamforming in order to improve the channel gain. Here, the beamforming may include transmission beamforming and reception beamforming. For example, the base station 110, the relays 120 and 160, and the UEs 130, 140, 150, and 170 may impart directivity to a transmission signal or a reception signal. To this end, the base station 110, the relays 120 and 160, and the UEs 130, 140, 150, and 170 may select serving beams 112, 113, 121, 131, 141, 151, 161, and 171 through a beam search or beam management procedure. After the serving beams 112, 113, 121, 131, 141, 151, 161, and 171 are selected, communication may be performed through a resource having a quasi-co-located (QCL) relationship with a resource transmitting the serving beams 112, 113, 121, 131, 141, 151, 161, and 171.

If the large-scale characteristics of a channel carrying a symbol on a first antenna port can be inferred from a channel carrying a symbol on a second antenna port, the first antenna port and the second antenna port can be evaluated to be in a QCL relationship. The large-scale characteristics may include, for example, at least one of a delay spread, a Doppler spread, a Doppler shift, an average gain, an average delay, and a spatial receiver parameter.

The UEs 130, 140, 150, and 170 shown in FIGS. 1A and 1B may support vehicle communication. In case of vehicle communication, the standardization for vehicle-to-everything (V2X) technology was completed in 3GPP Release 14 and Release 15 based on the device-to-device (D2D) structure in the LTE system, and also completed in 3GPP Release 16 based on the 5G NR. The NR V2X supports unicast communication, groupcast (or multicast) communication, and broadcast communication between UEs. In addition, contrary to the LTE V2X that aims for transmitting and receiving basic safety information necessary for vehicle road driving, the NR V2X aims for providing more advanced services, such as group driving (platooning), advanced driving, extended sensor, and remote driving. V2X services may be classified into basic safety services and advanced services. The basic safety services may include detailed services, such as a vehicle notification (e.g., cooperative awareness message (CAM) or basic safety message (BSM)) service, a left turn notification service, a front-vehicle collision warning service, an emergency vehicle approach notification service, a forward obstacle warning service, and an intersection signal information service, and V2X information may be transmitted/received using a broadcast, unicast, or groupcast transmission scheme. The advanced services have reinforced quality of service (QoS) requirements than the basic safety services, and need a method for transmitting and receiving V2X information by using a unicast or groupcast transmission scheme in addition to a broadcast transmission scheme so that V2X information can be transmitted and received within a specific vehicle group or between two vehicles. The advanced services may include detailed services, such as a platooning service, an autonomous driving service, a remote driving service, and an extended sensor-based V2X service. In addition, the NR V2X may provide a public safety service by supporting a direct communication service between UEs in an area where there is no network infrastructure.

Hereinafter, a sidelink (SL) refers to a signal transmission/reception path between UEs or a signal transmission/reception path between a UE and a relay, which may be used interchangeably with the PC5 interface. In the disclosure, a base station, which is an entity that allocates resources for a UE and a relay, may be a base station that supports both V2X communication and general cellular communication, or a base station that supports only V2X communication. For example, the base station may refer to an NR base station (e.g., gNB), an LTE base station (e.g., eNB), or a road site unit (RSU). In the disclosure, a terminal may include a user equipment (UE), a mobile station, a vehicle that supports vehicular-to-vehicular (V2V) communication, a vehicle or pedestrian's handset (e.g., smartphone) that supports vehicular-to-pedestrian (V2P) communication, a vehicle that supports vehicular-to-network (V2N) communication, a vehicle that supports vehicular-to-infrastructure (V2I) communication, an RSU having a UE function, an RSU having a base station function, or an RSU having a part of a base station function and a part of a UE function.

In the disclosure, a user equipment (UE) may refer to a vehicle that supports vehicular-to-vehicular (V2V) communication, a vehicle or pedestrian's handset (e.g., smartphone) that supports vehicular-to-pedestrian (V2P) communication, a vehicle that supports vehicular-to-network (V2N) communication, or a vehicle that supports vehicular-to-infrastructure (V2I) communication. In addition, the UE may refer to a user device that supports communication between devices of a public safety network.

In addition, the UE may refer to a road site unit (RSU) having a UE function, an RSU having a base station function, or an RSU having a part of a base station function and a part of a UE function.

In the disclosure, a relay may refer to a vehicle that supports V2X communication, or a user device that supports communication between devices of a public safety network. In addition, the relay may refer to a device having a UE function, a device having a base station function, or a device having a part of a UE function and a part of a base station function.

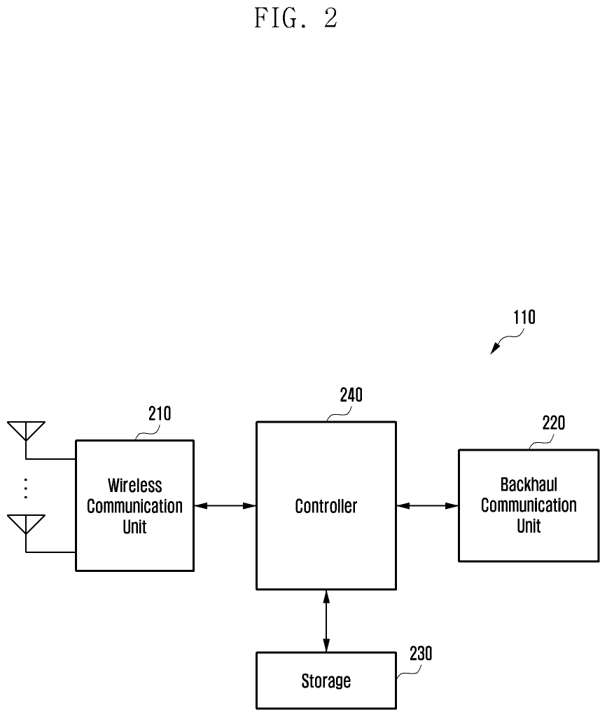

FIG. 2 is a diagram illustrating a configuration of a base station in a wireless communication system according to an embodiment of the disclosure.

Shown in FIG. 2 may be understood as the configuration of the base station 110. The term ‘unit’ used herein refers to a unit that processes at least one function or operation, which may be implemented as hardware, software, or a combination thereof

Referring to FIG. 2, the base station 110 may include a wireless communication unit 210, a backhaul communication unit 220, a storage 230, and a controller 240. However, components of the base station 110 are not limited to the above-listed components. Alternatively, the base station 110 may include more or fewer components than the above components. In addition, the wireless communication unit 210, the backhaul communication unit 220, the storage 230, and the controller 240 may be implemented in the form of a single chip. In addition, the controller 240 may include one or more processors.

The wireless communication unit 210 may perform functions for transmitting and receiving a signal through a wireless channel For example, the wireless communication unit 210 may perform a conversion function between a baseband signal and a bit stream in accordance with a physical layer standard of the system. When transmitting data, the wireless communication unit 210 may generate complex symbols by encoding and modulating a bit stream to be transmitted. In addition, when receiving data, the wireless communication unit 210 may restore received bit stream by demodulating and decoding a baseband signal.

In addition, the wireless communication unit 210 up-converts a baseband signal into a radio frequency (RF) band signal, transmits it through an antenna, and down-converts an RF band signal received through an antenna into a baseband signal. To this end, the wireless communication unit 210 may include a transmission filter, a reception filter, an amplifier, a mixer, an oscillator, a digital-to-analog converter (DAC), an analog-to-digital converter (ADC), and the like. In addition, the wireless communication unit 210 may include a plurality of transmission/reception paths. Furthermore, the wireless communication unit 210 may include at least one antenna array including a plurality of antenna elements.

In terms of hardware, the wireless communication unit 210 may be including a digital unit and an analog unit. The analog unit may be including a plurality of sub-units depending on operating power, operating frequency, etc., and the digital unit may be implemented by at least one processor (e.g., a digital signal processor (DSP)).

The wireless communication unit 210 transmits and receives a signal as mentioned above. Accordingly, all or part of the wireless communication unit 210 may be referred to as a ‘transmitter’, a ‘receiver’, or a ‘transceiver’. In the following description, transmission and reception performed through a wireless channel are used in the meaning of including the above-described processing performed by the wireless communication unit 210.

The backhaul communication unit 220 may provide an interface for performing communication with other nodes in the network. For example, the backhaul communication unit 220 may convert a bit string, to be transmitted from the base station 110 to other node, for example, other access node, other base station, an upper node, a core network, etc., into a physical signal, and may also convert a physical signal received from other node into a bit string.

The storage 230 may store a default program for the operation of the base station 110, an application program, and data, such as setting information. The storage 230 may be including a volatile memory, a non-volatile memory, or a combination thereof The storage 230 may provide stored data in response to a request of the controller 240.

The controller 240 may control overall operations of the base station 110. For example, the controller 240 may transmit and receive a signal through the wireless communication unit 210 or through the backhaul communication unit 220. In addition, the controller 240 writes and reads data in the storage 230. In addition, the controller 240 may perform functions of a protocol stack required by the communication standard. In another implementation example, the protocol stack may be included in the wireless communication unit 210. The controller 240 may include at least one processor. According to embodiments of the disclosure, the controller 240 may control the base station 110 to perform operations of the embodiments to be described later.

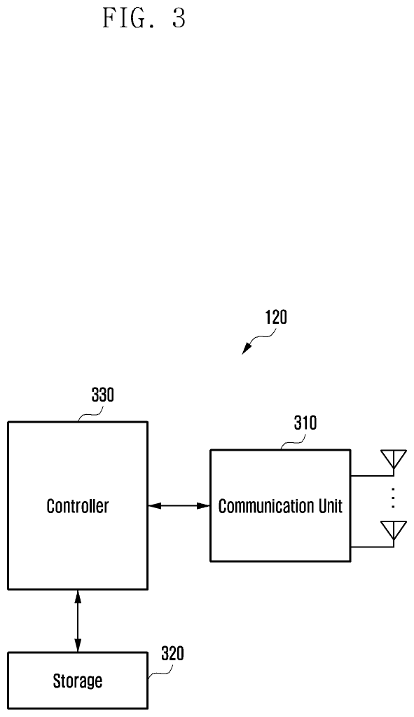

FIG. 3 is a diagram illustrating a configuration of a UE in a wireless communication system according to an embodiment of the disclosure.

Shown in FIG. 3 may be understood as the configuration of the UE 120. The term ‘unit’ used herein refers to a unit that processes at least one function or operation, which may be implemented as hardware, software, or a combination thereof

Referring to FIG. 3, the UE 120 may include a wireless communication unit 310, a storage 320, and a controller 330. However, components of the UE 120 are not limited to the above-listed components. Alternatively, the UE 120 may include more or fewer components than the above components. In addition, the wireless communication unit 310, the storage 320, and the controller 330 may be implemented in the form of a single chip. In addition, the controller 330 may include one or more processors.

The wireless communication unit 310 may perform functions for transmitting and receiving a signal through a wireless channel For example, the wireless communication unit 310 may perform a conversion function between a baseband signal and a bit stream in accordance with a physical layer standard of the system. When transmitting data, the wireless communication unit 310 may generate complex symbols by encoding and modulating a bit stream to be transmitted. In addition, when receiving data, the wireless communication unit 310 may restore received bit stream by demodulating and decoding a baseband signal. In addition, the wireless communication unit 310 up-converts a baseband signal into an RF band signal, transmits it through an antenna, and down-converts an RF band signal received through an antenna into a baseband signal. For example, the wireless communication unit 310 may include a transmission filter, a reception filter, an amplifier, a mixer, an oscillator, a DAC, an ADC, and the like.

In addition, the wireless communication unit 310 may include a plurality of transmission/reception paths. Furthermore, the wireless communication unit 310 may include at least one antenna array including a plurality of antenna elements. In terms of hardware, the wireless communication unit 310 may be including a digital unit and an analog unit (e.g., a radio frequency integrated circuit (RFIC)). The digital circuit and the analog circuit may be implemented in one package. In addition, the wireless communication unit 310 may include a plurality of RF chains. Furthermore, the wireless communication unit 310 may perform beamforming.

The wireless communication unit 310 transmits and receives a signal as mentioned above. Accordingly, all or part of the wireless communication unit 310 may be referred to as a ‘transmitter’, a ‘receiver’, or a ‘transceiver’. In the following description, transmission and reception performed through a wireless channel are used in the meaning of including the above-described processing performed by the wireless communication unit 310.

The storage 320 may store a default program for the operation of the UE 120, an application program, and data, such as setting information. The storage 320 may be including a volatile memory, a non-volatile memory, or a combination thereof The storage 320 may provide stored data in response to a request of the controller 330.

The controller 330 may control overall operations of the UE 120. For example, the controller 330 may transmit and receive a signal through the wireless communication unit 310. In addition, the controller 330 writes and reads data in the storage 320. In addition, the controller 330 may perform functions of a protocol stack required by the communication standard. To this end, the controller 330 may include at least one processor or microprocessor, or may be a part of the processor. In addition, a part of the wireless communication unit 310 and the controller 330 may be referred to as a communication processor (CP). According to embodiments of the disclosure, the controller 330 may control the UE 120 to perform operations of the embodiments to be described later.

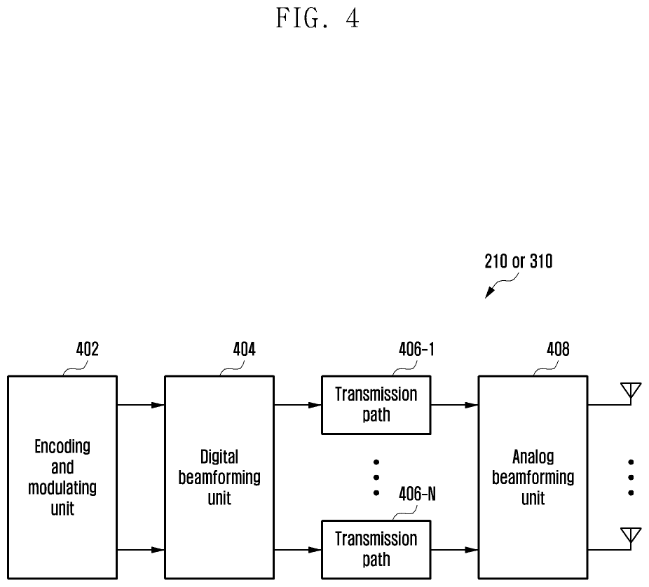

FIG. 4 is a diagram illustrating a configuration of a communication unit in a wireless communication system according to an embodiment of the disclosure.

FIG. 4 shows an example of a configuration of the wireless communication unit 210 shown in FIG. 2 or the wireless communication unit 310 shown in FIG. 3. Specifically, FIG. 4 shows components for performing beamforming as a part of the wireless communication unit 210 of FIG. 2 or the wireless communication unit 310 of FIG. 3.

Referring to FIG. 4, the wireless communication unit 210 or the wireless communication unit 310 may include an encoding and modulating unit 402, a digital beamforming unit 404, a plurality of transmission paths 406-1 to 406-N, and an analog beamforming unit 408.

The encoding and modulating unit 402 may perform channel encoding. For channel encoding, at least one of a low density parity check (LDPC) code, a convolution code, and a polar code may be used. The encoding and modulating unit 402 generates modulation symbols by performing constellation mapping.

The digital beamforming unit 404 may perform beamforming for a digital signal (e.g., modulation symbols). To this end, the digital beamforming unit 404 multiplies the modulation symbols by beamforming weights. Here, the beamforming weights are used to change the magnitude and phase of a signal, and may be referred to as a ‘precoding matrix’, a ‘precoder’, or the like. The digital beamforming unit 404 may output digital-beamformed modulation symbols to the plurality of transmission paths 406-1 to 406-N. In this case, based on a multiple input multiple output (MIMO) transmission technique, the modulation symbols may be multiplexed, or the same modulation symbols may be provided to the plurality of transmission paths 406-1 to 406-N.

The plurality of transmission paths 406-1 to 406-N may convert digital-beamformed digital signals into analog signals. To this end, each of the plurality of transmission paths 406-1 to 406-N may include an inverse fast Fourier transform (IFFT) calculator, a cyclic prefix (CP) inserter, a DAC, and an up-converter. The CP inserter is suitable for an orthogonal frequency division multiplexing (OFDM) scheme, and may be excluded when any other physical layer scheme (e.g., a filter bank multi-carrier (FBMC)) is applied. For example, the plurality of transmission paths 406-1 to 406-N may provide an independent signal processing process for a plurality of streams generated through digital beamforming. However, depending on the implementation type, some of the components of the plurality of transmission paths 406-1 to 406-N may be used in common.

The analog beamforming unit 408 may perform beamforming for an analog signal. To this end, the analog beamforming unit 408 may multiply the analog signals by beamforming weights. Here, the beamforming weights are used to change the magnitude and phase of a signal. Specifically, the analog beamforming unit 408 may be variously configured depending on a connection structure between the plurality of transmission paths 406-1 to 406-N and the antennas. For example, each of the plurality of transmission paths 406-1 to 406-N may be connected to one antenna array. In another example, the plurality of transmission paths 406-1 to 406-N may be connected to one antenna array. In still another example, the plurality of transmission paths 406-1 to 406-N may be adaptively connected to one antenna array or connected to two or more antenna arrays.

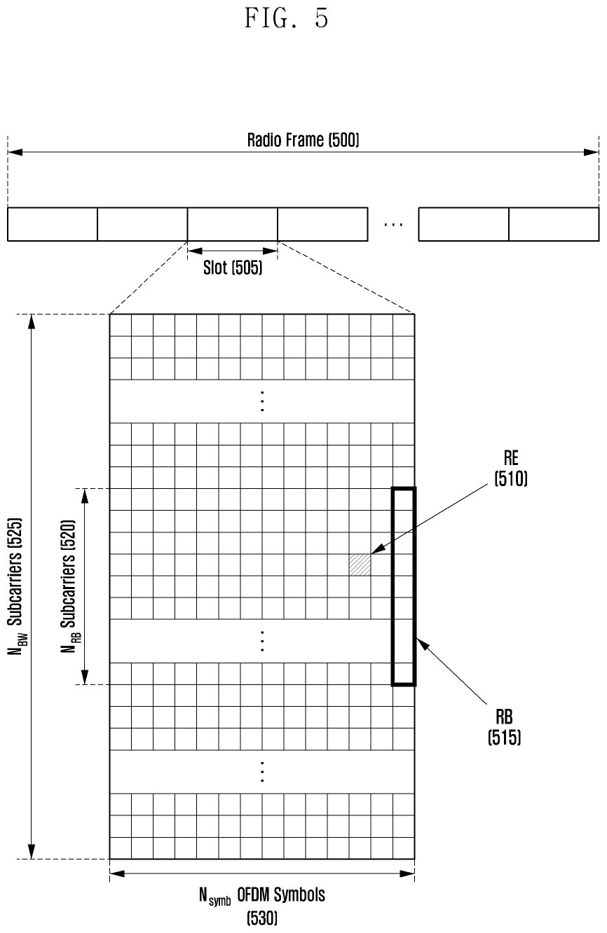

FIG. 5 is a diagram illustrating a structure of a time-frequency resource of a wireless communication system according to an embodiment of the disclosure.

Referring to FIG. 5, in a radio resource region, the horizontal axis represents the time domain and the vertical axis represents the frequency domain. The minimum transmission unit in the time domain is an OFDM symbol or a DFT-S-OFDM symbol, and N_{symb} OFDM symbols or DFT-S-OFDM symbols 530 may be included in one slot 505. Unlike the slot, the length of a subframe may be defined as 1.0 ms in the NR system, and the length of a radio frame 500 may be defined as 10 ms. The minimum transmission unit in the frequency domain is a subcarrier, and the bandwidth of the entire system transmission band may include N_{BW} subcarriers 525 in total. Specific values, such as N_{symb} and N_{BW} may be variably applied depending on the system.

The basic unit of a time-frequency resource region is a resource element (RE) 510, which may be represented by an OFDM symbol index or a DFT-S-OFDM symbol index and a subcarrier index. A resource block (RB) 515 may be defined as consecutive N_{RB} subcarriers 520 in the frequency domain. In general, the minimum transmission unit of data is an RB unit, and in the NR system, N_{symb} is 14 and N_{RB} is 12.

The structure of the time-frequency resource as shown in FIG. 5 may be applied to the Uu interface. In addition, the time-frequency resource structure shown in FIG. 5 may be similarly applied to the sidelink.

The sidelink relay may be authorized to be used in at least one or combination of a specific service, a specific UE, a specific sidelink flow, a specific sidelink bearer, a specific unicast link, a specific source identifier, and a specific destination identifier. The sidelink relay may establish a direct connection with an authenticated UE at the time of installation. Upon receiving a relay discovery message from an authenticated UE, the sidelink relay may establish a direct connection with that UE.

When the UE transmits and receives a control message and data to and from the base station through the relay and the sidelink, the UE may acquire through the relay a system information message and a paging message transmitted by the base station. For example, system information necessary for the UE to perform sidelink communication, such as system information block (SIB)12, SIB13, and SIB14, and system information including cell selection/cell reselection information may be needed when the UE performs data transmission/reception with the base station through the relay. In case that the UE should monitor a paging message or a system information message in the RRC_INACTIVE state or the RRC_IDLE state, monitoring the paging message or system information message of the relay may reduce power consumption of the UE rather than monitoring the paging message or system information message of the base station. Like the UEs 130 and 131 shown in FIG. 1A, the UE may be located within the area of the base station. In this case, the UE may directly monitor the system information message or paging message transmitted by the base station, and also monitor the system information message or paging message transmitted through the relay. Like the UEs 140 and 141 shown in FIG. 1A, the UE may be located outside the area of the base station. In this case, the UE may monitor the system information message or paging message transmitted through the relay.

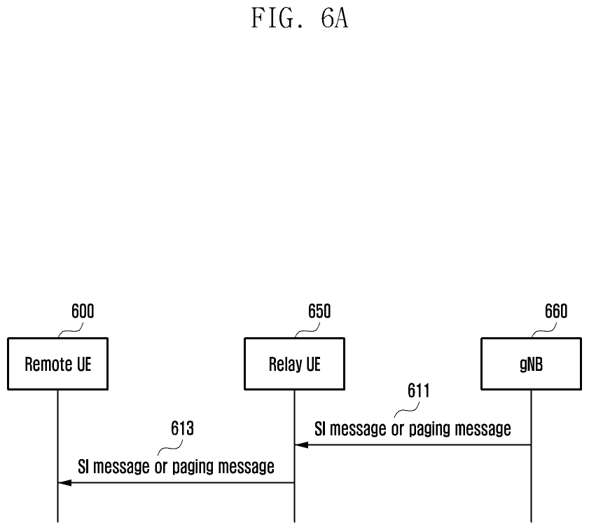

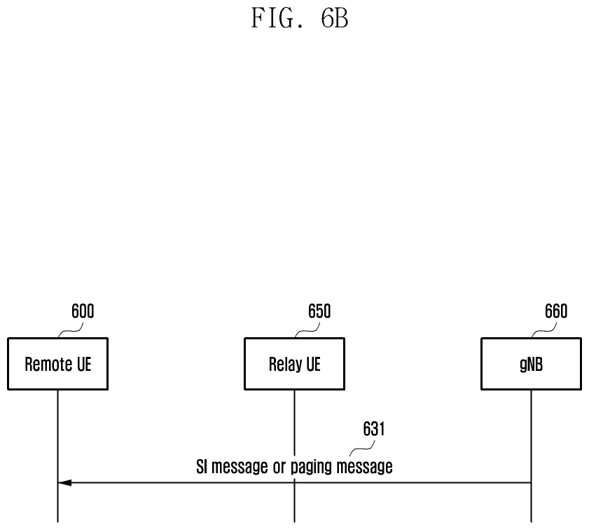

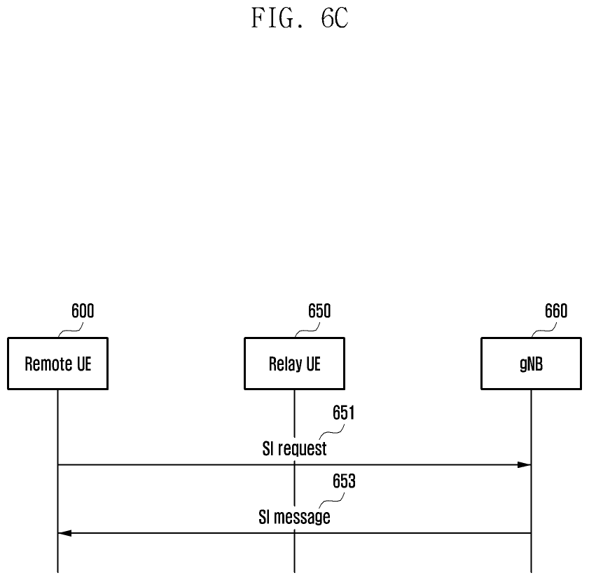

FIG. 6A is a diagram illustrating a signal flow of acquiring a system information message and a paging message at a UE according to an embodiment of the disclosure.

Referring to FIG. 6A, a base station (e.g., gNB) 660 may transmit a system information message or paging message at operation 611. A relay (e.g., a relay UE) 650 may monitor and acquire the system information message or paging message transmitted by the base station 660 and, at operation 613, transmit the acquired system information message or paging message via a sidelink. The system information message or paging message transmitted by the relay 650 at the operation 613 may correspond to the system information message or paging message as it is acquired from the base station 660. Alternatively, the system information message or paging message transmitted by the relay 650 at the operation 613 may correspond to the system information message or paging message processed by the relay 650. A Remote UE 600 may monitor and acquire the system information message or paging message transmitted by the relay 650. Here, the Remote UE 600 may include at least one or more UEs performing sidelink communication with the relay 650.

FIG. 6B is a diagram illustrating a signal flow of acquiring a system information message and a paging message at a UE according to an embodiment of the disclosure.

Referring to FIG. 6B, the base station 660 may transmit the system information message or paging message at operation 631. The Remote UE 600 may monitor and acquire the system information message or paging message transmitted by the base station 660. Here, the Remote UE 600 may include at least one or more UEs performing sidelink communication with the relay 650.

FIG. 6C is a diagram illustrating a signal flow of acquiring a system information message and a paging message at a UE according to an embodiment of the disclosure.

Referring to FIG. 6C, the Remote UE 600 may transmit a message requesting the system information message to the base station 660 at operation 651. Upon receiving the message requesting the system information message from the Remote UE 600, the base station 660 may transmit the system information message to the Remote UE 600 at operation 653. The system information request message and the system information message of the operations 651 and 653 may be transmitted and received through the Uu interface between the UE and the base station. Here, the Remote UE 600 may include at least one or more UEs performing sidelink communication with the relay 650.

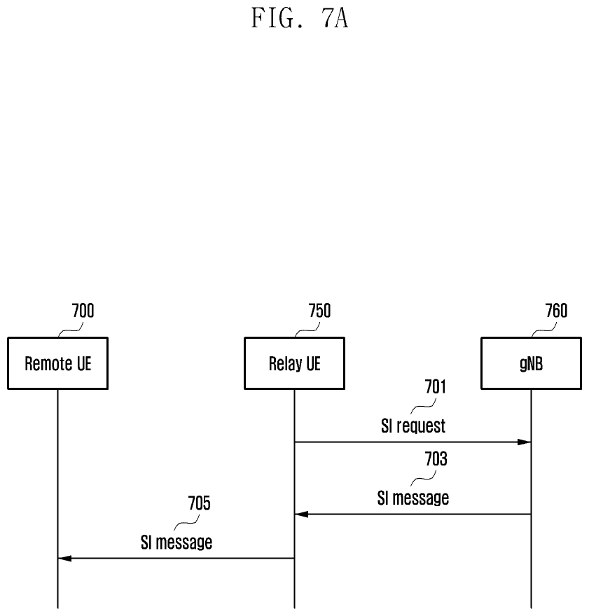

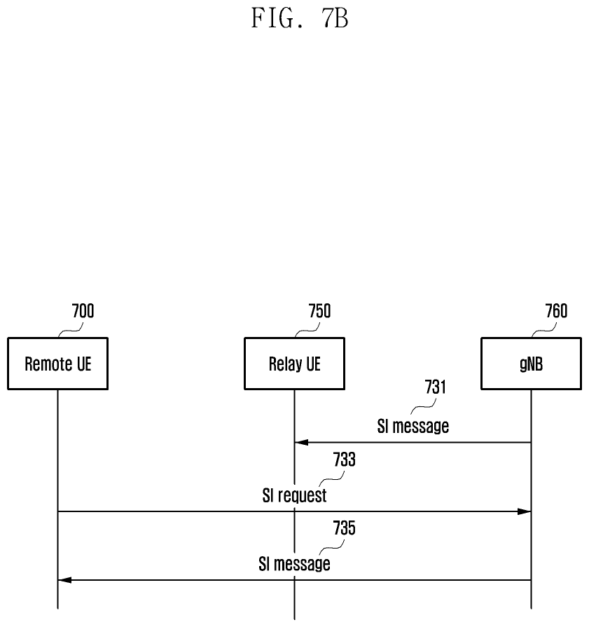

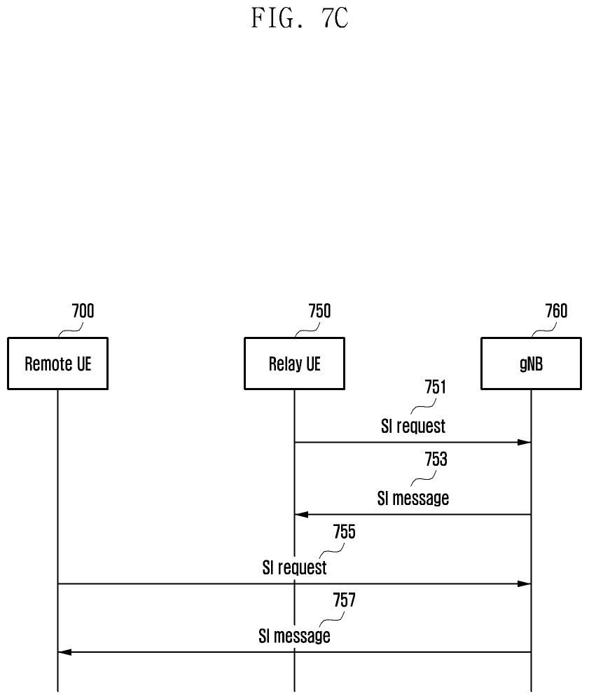

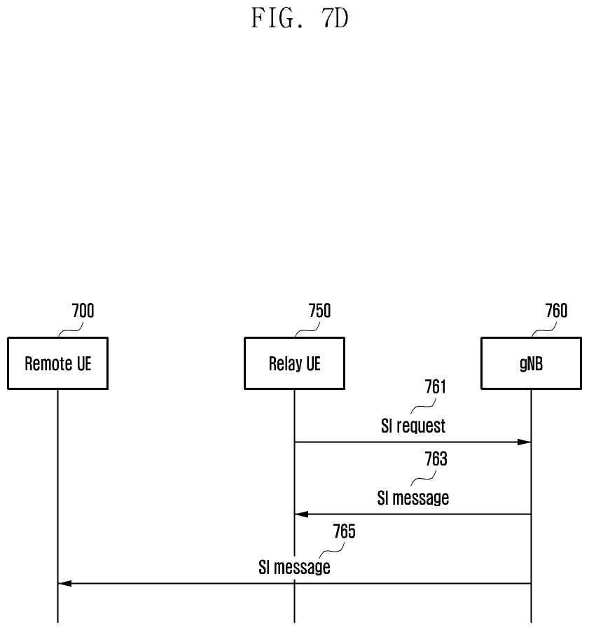

In addition to methods shown in FIGS. 6A to 6C, embodiments in which the UE or the relay acquires and processes the system information message transmitted by the base station when the UE performs transmission/reception of data or a control message with the base station through a sidelink connection with the relay will be described with reference to FIGS. 7A to 7D.

FIG. 7A is a diagram illustrating a signal flow of acquiring a system information message at a UE according to an embodiment of the disclosure.

Referring to FIG. 7A, a Remote UE 700 may perform data transmission/reception with a base station (e.g., gNB) 760 through a sidelink direct connection with a relay (e.g., relay UE) 750. Alternatively, the Remote UE 700 may be in the RRC_INACTIVE state or RRC_IDLE state with respect to the base station 760 and establish a sidelink direct connection with the relay 750. The relay 750 may transmit a system information request message to the base station 760 at operation 701. The base station 760 may process the system information request message of the relay 750 and transmit a system information message to the relay 750 at operation 703. The relay 750 may acquire the system information message at the operation 703. The system information message acquired by the relay 750 at the operation 703 may include at least one of a system information message required for the relay 750 and a system information message required for at least one Remote UE 700 capable of transmitting and receiving a message to and from the relay 750 through the sidelink. The relay 750 may process the acquired system information message and transmit the acquired system information message to the at least one Remote UE 700 at operation 705. The system information message transmitted to the Remote UE 700 by the relay 750 at the operation 705 may be identical with the system information message acquired from the base station 760 at the operation 703 or be a system information message processed to contain system information determined to be necessary for the UE 700.

FIG. 7B is a diagram illustrating a signal flow of acquiring a system information message at a UE according to an embodiment of the disclosure.

Referring to FIG. 7B, the Remote UE 700 may perform data transmission/reception with the base station 760 through a sidelink direct connection with the relay 750. Alternatively, the UE 700 may be in the RRC_INACTIVE state or RRC_IDLE state with respect to the base station 760 and establish a sidelink direct connection with the relay 750. The base station 760 may transmit a system information message at operation 731, and the relay 750 may acquire and process the system information message transmitted by the base station 760 at the operation 731. The Remote UE 700 may transmit a system information request message to the base station 760 at operation 733. The base station 760 may process the system information request message of the UE 700 and transmit the system information message to the Remote UE 700 at operation 735. The Remote UE 700 may process the system information message acquired from the base station 760.

FIG. 7B may be used when the relay 750 does not transmit through the sidelink the system information message transmitted by the base station 760. In addition, FIG. 7B may be used when it is not configured to relay the system information message transmitted by the base station 760 in sidelink-based relay configuration between the UE 700 and the relay 750. In addition, FIG. 7B may be used when the Remote UE 700 does not request the relay 750 to relay the system information message transmitted by the base station 760.

FIG. 7C is a diagram illustrating a signal flow of acquiring a system information message at a UE according to an embodiment of the disclosure.

Referring to FIG. 7C, the Remote UE 700 may perform data transmission/reception with the base station 760 through a sidelink direct connection with the relay 750. Alternatively, the Remote UE 700 may be in the RRC_INACTIVE state or RRC_IDLE state with respect to the base station 760 and establish a sidelink direct connection with the relay 750. The relay 750 may transmit a system information request message to the base station 760 at operation 751. The base station 760 may process the system information request message of the relay 750 and transmit a system information message to the relay 750 at operation 753. The relay 750 may acquire the system information message at the operation 753. The Remote UE 700 may transmit a system information request message to the base station 760 at operation 755. The base station 760 may process the system information request message of the Remote UE 700 and transmit the system information message to the Remote UE 700 at operation 757. The Remote UE 700 may process the system information message acquired from the base station 760.

FIG. 7C may be used when the relay 750 does not transmit through the sidelink the system information message transmitted by the base station 760. In addition, FIG. 7C may be used when it is not configured to relay the system information message transmitted by the base station 760 in sidelink-based relay configuration between the UE 700 and the relay 750. In addition, FIG. 7C may be used when the Remote UE 700 does not request the relay 750 to relay the system information message transmitted by the base station 760.

FIG. 7D is a diagram illustrating a signal flow of acquiring a system information message at a UE according to an embodiment of the disclosure.

Referring to FIG. 7D, the Remote UE 700 may perform data transmission/reception with the base station 760 through a sidelink direct connection with the relay 750. Alternatively, the Remote UE 700 may be in the RRC_INACTIVE state or RRC_IDLE state with respect to the base station 760 and establish a sidelink direct connection with the relay 750. The relay 750 may transmit a system information request message to the base station 760 at operation 761. The base station 760 may process the system information request message of the relay 750 and transmit a system information message to the relay 750 at operation 763. The relay 750 may acquire the system information message at the operation 763. The Remote UE 700 may acquire and process the system information message transmitted by the base station 760 at operation 765.

FIG. 7D may be used when the relay 750 does not transmit through the sidelink the system information message transmitted by the base station 760. In addition, FIG. 7D may be used when it is not configured to relay the system information message transmitted by the base station 760 in sidelink-based relay configuration between the Remote UE 700 and the relay 750. In addition, FIG. 7D may be used when the Remote UE 700 does not request the relay 750 to relay the system information message transmitted by the base station 760.

In another embodiment of the disclosure, in case that data transmission and reception can be performed through the sidelink connection between the Remote UE and the relay, the UE may separately transmit a system information message request to the relay and acquire and process a system information message from the relay. The system information message that the Remote UE can acquire/process from the relay after transmitting the system information message request to the relay through the sidelink connection may include, for example, all system information messages that the base station can support, and/or a system information message that is configured to be transmittable through the relay in the base station. The system information message configured to be transmittable through the relay may be, for example, but is not limited to, a system information message (at least one of NR SIB12, NR SIB13, NR SIB14, LTE SIB21, and LTE SIB26) containing configuration information for the Remote UE to perform sidelink communication, and a system information message containing configuration information for the Remote UE to perform cell selection/reselection and cell selection/reselection measurement operations. The base station may inform the Remote UE about a list of supportable system information messages (SIB index list or SIB bitmap) that the Remote UE can request from the relay through the sidelink connection in a cell of the base station. The base station may inform the Remote UE about information on whether the Remote UE can receive a system information message from the relay through the sidelink connection with respect to each system information message supportable in a cell of the base station. The base station may inform the Remote UE about information on whether the Remote UE can request a system information message from the relay through the sidelink connection with respect to each system information message supportable in a cell of the base station. Such information may be delivered to the Remote UE through at least one of an SIB message, an RRC dedicated message, or a paging message transmitted by the base station. In another embodiment of the disclosure, when the Remote UE can request through the sidelink the transmission of all system information messages supported by the base station, or when the Remote UE can receive all system information messages through the relay, at least one of a list of supportable system information messages, transmission support configuration information of the relay for each system information message, and transmission request support configuration information to the relay for each system information message may be omitted.

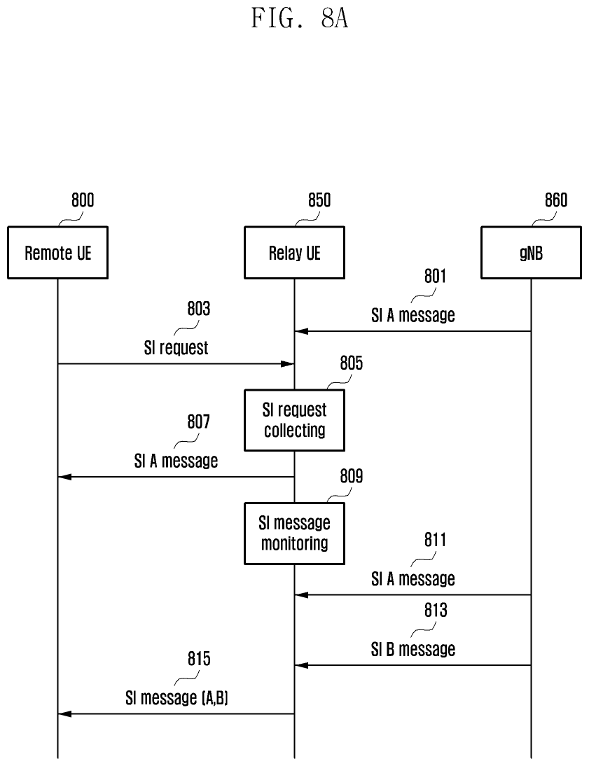

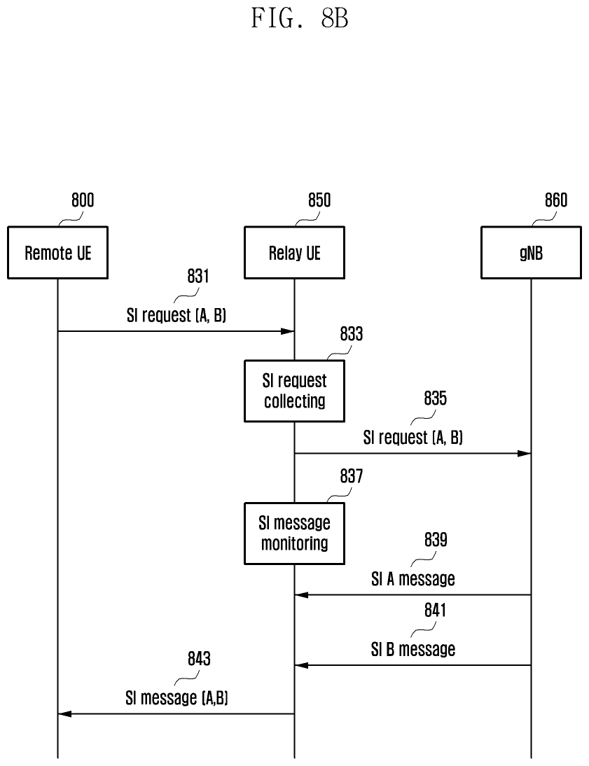

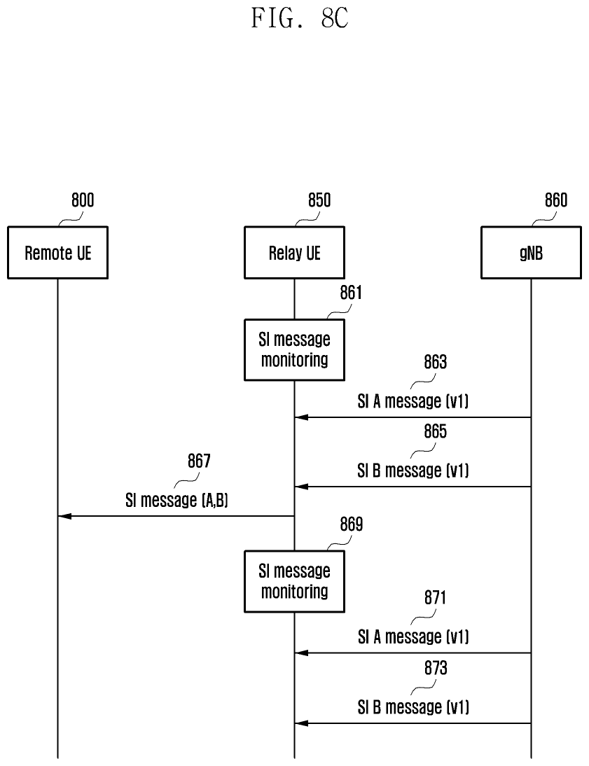

The relay may inform the Remote UE about a list of supportable system information messages (SIB index list or SIB bitmap) that the Remote UE can request from the relay through the sidelink connection in a cell of the base station. The relay may inform the Remote UE about information on whether the Remote UE can receive a system information message from the relay through the sidelink connection with respect to each system information message supportable in a cell of the base station. The relay may inform the Remote UE about information on whether the Remote UE can request a system information message from the relay through the sidelink connection with respect to each system information message supportable in a cell of the base station. Such information may be delivered to the Remote UE through at least one of a sidelink SIB message, a sidelink RRC dedicated message, sidelink control information (SCI), or a sidelink paging message transmitted by the relay. In another embodiment of the disclosure, when the Remote UE can request through the sidelink the transmission of all system information messages supported by the base station, or when the Remote UE can receive all system information messages through the relay, at least one of a list of supportable system information messages, transmission support configuration information of the relay for each system information message, and transmission request support configuration information to the relay for each system information message may be omitted. Various embodiments of a method in which the Remote UE transmits a message requesting a system information message to the relay through the sidelink and receives the system information message through the sidelink with the relay will be described with reference to FIGS. 8A to 8C. In these embodiments of the disclosure, a Remote UE 800 may perform data transmission/reception with a base station (e.g., gNB) 860 through a sidelink direct connection with a relay (e.g., relay UE) 850 in the RRC_CONNECTED state. Alternatively, the Remote UE 800 may be in the RRC_INACTIVE state or RRC_IDLE state with respect to the base station 860 and establish a sidelink direct connection with the relay 850.

FIG. 8A is a diagram illustrating a signal flow of acquiring a system information message at a UE according to an embodiment of the disclosure.

Referring to FIG. 8A, at operation 801, the relay 850 may acquire and process a system information message transmitted by the base station 860. At the operation 801, the relay 850 may acquire the system information message as a response of the base station 860 to a system information request message of the relay 850, or acquire the system information message by monitoring the system information message transmitted by the base station 860. For example, the system information message acquired from the base station 860 by the relay 850 at the operation 801 may include an SI A message. At operation 803, the relay 850 may acquire a system information request message from at least one Remote UE 800. At operation 805, the relay 850 may collect system information request messages acquired from the at least one Remote UE 800. If it is determined that the relay 850 has a system information message requested by the Remote UE 800 and the system information message is not changed, the relay 850 may transmit the system information message requested by the Remote UE 800 at operation 807. At the operation 807, the system information message requested by the Remote UE 800 is, for example, an SI A message. The relay 850 may continuously perform the operation of monitoring the system information message at operation 809. At the operation 809, the relay 850 may monitor a system information message required by the relay 850 and a system information message required in the system information request message collected at the operation 805. The relay 850 may acquire system information messages, for example, an SI A message and an SI B message, at operations 811 and 813. The operation of the operation 811 or 813 may be performed at the time of transmission of the SI message requested by the Remote UE 800 at the operation 803 and determined to be monitored by the relay 850 at the operation 809. For example, when the SI A message is transmitted at the transmission time X and the SI B message is transmitted at the transmission time X+N according to system information message scheduling (SI scheduling) of the base station 860, the relay 850 may monitor and acquire the SI A message and the SI B message at the time point X and the time point X+N, respectively. In another example, the SI A message and the SI B message may be transmitted at the transmission time Y according to the system information message scheduling (SI scheduling) of the base station 860, and the relay 850 may monitor and acquire the SI A message and the SI B message at the time point Y.

If it is determined that the corresponding SI message is not changed with respect to the system information request message collected at the operation 805 (determining whether the SI message is changed, based on at least one of SI scheduling information, area ID, cell ID, and value tag transmitted by the base station 860), the relay 850 may determine that there is no need to monitor and acquire the corresponding SI message transmitted from the base station 860. In addition to the system information message requested by the Remote UE 800, the relay 850 may check whether the SI message for the system information message required for the relay 850 itself is changed, and depending on whether the SI message is changed, the relay 850 may or may not perform operations of monitoring and acquiring the system information message required for the relay 850.

If it is determined that the system information messages, the SI A message and the SI B message, acquired at the operations 811 and 813 are the system information messages required in the system information request message collected at the operation 805, the relay 850 may transmit the system information messages including SI A and SI B to the Remote UE 800 through the sidelink at operation 815.

If it is determined that the relay 850 has a history of transmitting the system information message requested by the Remote UE 800 to the Remote UE 800 and the corresponding system information message is not changed, the relay 850 does not need to transmit the corresponding system information message to the Remote UE 800. For example, when it is determined that the system information message is changed after transmitted to the Remote UE 800, the relay 850 may transmit the system information message to the requesting Remote UE 800.

In an embodiment of a method for the relay 850 to transmit the system information message to at least one Remote UE 800 through the sidelink at the operations 807 to 815, when it is determined that the system information message requested in the system information request message collected at the operation 805 is acquired and needs to be transmitted to the Remote UE 800, the relay 850 may transmit the system information message to the corresponding Remote UE 800 in a sidelink unicast scheme.

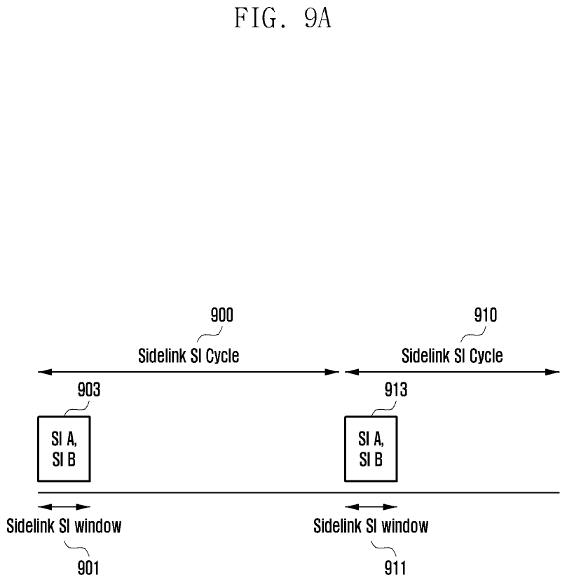

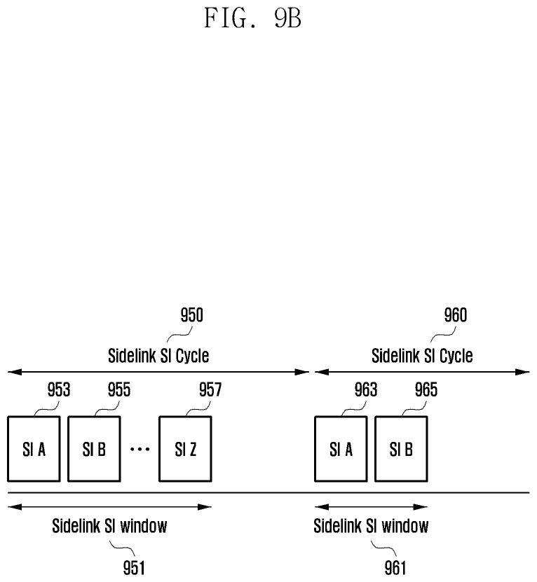

In an embodiment of a method for the relay 850 to transmit the system information message to at least one Remote UE 800 through the sidelink at the operations 807 to 815, when it is determined that the system information message requested in the system information request message collected at the operation 805 is acquired and needs to be transmitted to the Remote UE 800, the relay 850 may transmit sidelink SI message scheduling and then, according to the sidelink SI message scheduling, transmit the requested system information message to one or more Remote UEs 800 by using one of a unicast, groupcast, or broadcast scheme. Operations of the relay 850 and the Remote UE 800 that process the sidelink system information message scheduling will be described with reference to FIGS. 9A and 9B.

FIG. 8B is a diagram illustrating a signal flow of acquiring a system information message at a UE according to an embodiment of the disclosure.

Referring to FIG. 8B, a Remote UE 800 may transmit a system information request message to the relay 850 through the sidelink at operation 831. The system information request message may include information on an SI message that the Remote UE 800 is interested in. When the relay 850 receives the system information request message from at least one or more Remote UEs 800, the relay 850 may collect the system information request messages at operation 833. The relay 850 may transmit the system information request message to the base station 860 at operation 835. The system information request message of the operation 835 may include at least one of the system information request message of the Remote UE 800 collected at the operation 833 and a system information request message for a system information required by the relay 850. The RRC state of the relay 850 may correspond to one of an RRC_IDLE state, an RRC_INACTIVE state, or an RRC_CONNECTED state. The RRC state of the Remote UE 800 may correspond to one of an RRC_IDLE state, an RRC_INACTIVE state, or an RRC_CONNECTED state. When the relay 850 is in the RRC_IDLE state or the RRC_INACTIVE state, the relay 850 may request the base station 860 for a system information message required in the RRC_IDLE state or the RRC_INACTIVE state. When the relay 850 is in the RRC_CONNECTED state, the relay 850 may request the base station 860 for a system information message required in the RRC_CONNECTED state. If the relay 850 is in the RRC_CONNECTED state, the Remote UE 800 may be in the RRC_IDLE state or the RRC_INACTIVE state, and the system information request message of the Remote UE 800 collected at the operation 833 may include a system information request message for the system information message required in the RRC_IDLE state or the RRC_INACTIVE state. In this case, even if the relay 850 is in the RRC_CONNECTED state, the system information request message transmitted at the operation 835 may include the system information request message for the system information message required in the RRC_IDLE state or the RRC_INACTIVE state. In case that the relay 850 transmits the system information request message for the Remote UE 800, the base station 860 may set the relay 850, even if the relay 850 is in the RRC_CONNECTED state, to transmit the system information request message for the Remote UE 800 being in the RRC_IDLE state or the RRC_INACTIVE state.

If the relay 850 is in the RRC_IDLE state or the RRC_INACTIVE state, the Remote UE 800 may be in the RRC_CONNECTED state, and the system information request message of the Remote UE 800 collected at the operation 833 may include a system information request message for the system information message required in the RRC_CONNECTED state. In this case, even if the relay 850 is in the RRC_IDLE state or the RRC_INACTIVE state, the system information request message transmitted at the operation 835 may include the system information request message for the system information message required in the RRC_CONNECTED state. In case that the relay 850 transmits the system information request message for the Remote UE 800, the base station 860 may set the relay 850, even if the relay 850 is in the RRC_IDLE state or the RRC_INACTIVE state, to transmit the system information request message for the Remote UE 800 being in the RRC_CONNECTED state.

At operation 837, the relay 850 may monitor the system information message transmitted by the base station 860. At the operation 837, the relay 850 may monitor a system information message required by the relay 850 and a system information message required in the system information request message collected at the operation 833. The relay 850 may acquire system information messages, for example, an SI A message and an SI B message, at operations 839 and 841. The operation of the operation 839 or 841 may be performed at the time of transmission of the SI message collected from the Remote UE 800 at the operation 833 and determined to be monitored by the relay 850 at the operation 837. For example, when the SI A message is transmitted at the transmission time X and the SI B message is transmitted at the transmission time X+N according to system information message scheduling (SI scheduling) of the base station 860, the relay 850 may monitor and acquire the SI A message and the SI B message at the time point X and the time point X+N, respectively. In another example, the SI A message and the SI B message may be transmitted at the transmission time Y according to the system information message scheduling (SI scheduling) of the base station 860, and the relay 850 may monitor and acquire the SI A message and the SI B message at the time point Y.

If it is determined that the corresponding SI message is not changed with respect to the system information request message collected at the operation 833 (determining whether the SI message is changed, based on at least one of SI scheduling information, area ID, cell ID, and value tag transmitted by the base station 860), the relay 850 may determine that there is no need to monitor and acquire the corresponding SI message transmitted from the base station 860. In addition to the system information message requested by the Remote UE 800, the relay 850 may check whether the SI message for the system information message required for the relay 850 itself is changed, and depending on whether the SI message is changed, the relay 850 may or may not perform operations of monitoring and acquiring the system information message required for the relay 850.

If it is determined that the system information messages, the SI A message and the SI B message, acquired at the operations 839 and 841 are the system information messages required in the system information request message collected at the operation 833, the relay 850 may transmit the system information messages including SI A and SI B to the Remote UE 800 through the sidelink at operation 843.

If it is determined that the relay 850 has a history of transmitting the system information message requested by the Remote UE 800 to the Remote UE 800 and the corresponding system information message is not changed, the relay 850 does not need to transmit the corresponding system information message to the Remote UE 800. For example, when it is determined that the system information message is changed after transmitted to the Remote UE 800, the relay 850 may transmit the system information message to the requesting Remote UE 800.

In an embodiment of a method for the relay 850 to transmit the system information message to at least one Remote UE 800 through the sidelink at the operation 843, when it is determined that the system information message requested in the system information request message collected at the operation 833 is acquired and needs to be transmitted to the Remote UE 800, the relay 850 may transmit the system information message to the corresponding Remote UE 800 in a sidelink unicast scheme.

In an embodiment of a method for the relay 850 to transmit the system information message to at least one Remote UE 800 through the sidelink at the operation 843, when it is determined that the system information message requested in the system information request message collected at the operation 833 is acquired and needs to be transmitted to the Remote UE 800, the relay 850 may transmit sidelink SI message scheduling and then, according to the sidelink SI message scheduling, transmit the requested system information message to one or more Remote UEs 800 by using one of a unicast, groupcast, or broadcast scheme. Operations of the relay 850 and the Remote UE 800 that process the sidelink system information message scheduling will be described with reference to FIGS. 9A and 9B.

FIG. 8C illustrates a case in which the relay 850 performing an operation of monitoring and acquiring the system information message in response to the request of the Remote UE 800 determines whether the requested system information is changed, and processes the system information message transmission to the Remote UE 800.

FIG. 8C is a diagram illustrating a signal flow of acquiring a system information message at a UE according to an embodiment of the disclosure.

Referring to FIG. 8C, the relay 850 may monitor a system information message from the base station 860 at operation 861, based on a system information message request from at least one Remote UE 800 and a system information message required by the relay 850. For example, the system information message requested by the Remote UE 800 may include an SI A message and an SI B message. The relay 850 may acquire an SI update indication (at least one of SI scheduling information, area ID, cell ID, and value tag to be used in determining whether an SI message is changed) from the base station 860, and then determine whether at least one interested SI is changed, and whether at least one SI requested by the Remote UE 800 is changed. If it is determined that the SI message requested by the Remote UE 800 has been changed, the relay 850 may transmit the SI message to the Remote UE 800. If it is determined that the SI message requested by the Remote UE 800 is not changed, the relay 850 may not transmit the SI message to the Remote UE 800. For example, based on version information (v1) of the SI A and SI B messages monitored at operations 863 and 865, the relay 850 may determine whether there is a need to acquire the SI A message and the SI B message. If it is determined that there is a need to acquire the SI A message (version v1) and the SI B message (version v1), the relay 850 may acquire the SI A message and the SI B message. At operation 867, the relay 850 may transmit the system information messages, the SI A message and the SI B message, requested by the Remote UE 800 to the Remote UE 800 through the sidelink. If it is determined that there is a need to continuously monitor the system information message requested by the Remote UE 800, the relay 850 may monitor the system information message from the base station 860 at operation 869, based on the system information message request of the Remote UE 800 and the system information message required by the relay 850. Based on the version information (v1) of the SI A message and SI B message monitored at operations 871 and 873, the relay 850 may determine that there is no need to acquire the SI A message and the SI B message because the previously acquired SI messages are not changed. For example, because the SI message previously acquired and transmitted to the Remote UE 800 is not changed, the relay 850 may determine that there is no need to transmit the SI A message and the SI B message to the Remote UE 800. If it is determined that the system information message requested by the Remote UE 800 should be continuously monitored, the relay 850 may continue to monitor the system information message in response to the system information message request from the Remote UE 800.

In embodiments of FIGS. 8A to 8C, the system information request message transmitted to the relay 850 by the Remote UE 800 may correspond to at least one of an RRC message and a MAC CE message transmitted in the PC5 RRC unicast connection established between the Remote UE 800 and the relay 850. The system information request message transmitted to the relay 850 by the Remote UE 800 may include information on one or more SI messages that the Remote UE 800 is interested in. The SI message information requested by the Remote UE 800 may be represented by at least one of an SIB bitmap or a list of SIB indexes.

For example, assuming that the SI message consists of SIB1, SIB2, SIB3, SIB4, and SIB5, each bit of the SIB bitmap indicates an SIB message, and bit values 0 and 1 may indicate an SIB non-request and an SIB request, respectively. For example, if the UE requests SIB1, SIB3, and SIB5, the SIB bitmap may be expressed as 10101. In case that the SIB index list is used, the SIB index requested by the UE may be included. For example, if the UE requests SIB1, SIB3, and SIB5, indexes corresponding to SIB1, SIB3, and SIB5 may be represented in the system information request message. The Remote UE 800 may transmit the system information request message to the relay 850 even when the SI message information of interest is changed. In addition, even when the UE is no longer interested in acquiring the SI message, the Remote UE may transmit the system information request message to the relay 850 to inform that the relay transmission of the system information message is no longer necessary. In order to control the Remote UE not to frequently transmit the system information request message, an SI message request prohibit timer may be set. When the SI message request prohibit timer is set and running, the Remote UE 800 does not transmit the system information request message before the SI message request prohibit timer expires. When the SI message request prohibit timer expires and there is the system information request message to be transmitted, the Remote UE 800 may transmit the system information request message to the relay 850. Upon transmitting the system information request message, the Remote UE 800 may execute the SI message request prohibit timer again.

In FIGS. 8A to 8C, when the relay 850 and the Remote UE 800 transmit/receive the system information message through the sidelink, a signaling bearer for PC5 RRC unicast may be used. Alternatively, a separate PC5 RRC signaling bearer may be configured to transmit/receive the system information message through the sidelink between the relay 850 and the Remote UE 800. The separate PC5 RRC signaling bearer may be configured in a unicast scheme, a groupcast scheme, or a broadcast scheme.

In FIGS. 8A to 8C, the Remote UE 800 may transmit the system information request message to the relay 850 and then maintain the PC5 RRC configuration with the relay 850 so as to monitor and acquire the system information message from the relay 850. When the PC5 RRC configuration between the Remote UE 800 and the relay 850 is released, the relay 850 releases the system information request information of the Remote UE 800 and does not perform the operation of monitoring and acquiring the system information message of the corresponding Remote UE.

According to an embodiment of the disclosure, when the relay 850 transitions to the RRC_INACTIVE state or the RRC_IDLE state with the base station, the relay 850 may continuously perform the operation of monitoring and acquiring the system information required for the Remote UE 800 in response to the system information request message of the Remote UE 800. According to an embodiment of the disclosure, when the relay 850 transitions to the RRC_INACTIVE state or the RRC_IDLE state with the base station, the relay 850 releases the system information request information of the Remote UE 800 and does not perform the operation of monitoring and acquiring the system information message of the Remote UE.

The Remote UE 800 may request the relay 850 to release the system information request even when the PC5 RRC connection with the relay 850 is maintained, and the relay 850 does not perform the operation of monitoring and acquiring the system information message of the corresponding Remote UE. When at least one of a case that configuration is changed so as not to transmit the system information message through the relay or a case that configuration is changed so as not to request transmission of the system information message through the relay is satisfied, the Remote UE 800 may stop the operation of receiving the system information message through the relay 850 or transmitting the system information request message to the relay 850.

When at least one of a case that an indication that the Remote UE 800 is no longer interested in the SI message is received, a case that a relay function for the Remote UE 800 is stopped, a case that configuration is changed so as not to transmit the system information message through the relay, or a case that configuration is changed so as not to request transmission of the system information message through the relay is satisfied, the relay 850 may stop the operation of monitoring, acquiring and transmitting at least one SI message for at least one Remote UE 800.

SI request signaling or system information message relay request signaling for requesting transmission of at least one SI message for the relay 850 being in the RRC_INACTIVE state, RRC_IDLE state, or RRC_CONNECTED state with the base station 860 may include at least one SI message request transmitted to the relay 850 by at least one Remote UE 800 in FIGS. 8A to 8C. For each SI message supported by the cell of the base station, the relay 850 may determine whether it is configured as a system information message transmittable to the UE through the sidelink connection or configured to receive a system information request message from the UE. If it is determined that the SI message is configured as a system information message transmittable to the UE through the sidelink connection, the relay 850 may transmit the system information message to the UE through the sidelink connection. If it is determined that the SI message is configured to receive a system information request message from the UE through the sidelink connection, the relay 850 may acquire the system information request message from the Remote UE. For each SI message, if it is not configured to acquire the system information request message from the Remote UE through the sidelink connection or is not configured to transmit the system information to the UE through the sidelink connection, upon receiving a system information request message from the Remote UE 800, the relay 850 may reject the relay transmission through the sidelink connection for the corresponding SI message.

In case that at least one UE requests a system information message through the relay and acquires the system information message from the relay, the relay may set a predetermined timer (Tsi_delivery_request) and, when the timer expires, perform an operation of collecting system information message requests acquired from at least one UE while the timer is executed. Upon starting the operation of collecting the system information message requests from the Remote UE, the relay may restart the Tsi_delivery_request timer and perform an operation of receiving system information message requests from at least one UE. In another embodiment of the disclosure, upon completion of the operation of collecting the system information message request from the Remote UE, the relay may restart the Tsi_delivery_request timer and perform an operation of receiving system information message requests from at least one Remote UE.

In an embodiment of the disclosure, when the relay independently operates a message for transmitting its own system information request to the base station and a message for transmitting a system information request of the remote UE to the base station, the Tsi_delivery_request timer may be set for the purpose of composing a message for transmitting the system information request of the remote UE to the base station. In this case, the relay may use a timer (onDemandSIB-RequestProhibitTimer), which is used to restrict the relay's own system information request message transmission, to restrict the remote UE's system information request message transmission. For example, while T1 configured as the onDemandSIB-RequestProhibitTimer operates, the relay cannot transmit the system information request message of the remote UE to the base station.

In case that the relay processes a message requesting its own system information and a message requesting system information of the remote UE as the same message, embodiments in which the relay operates the Tsi_delivery_request and the onDemandSIB-RequestProhibitTimer, T1, are as follows.

(1) In an embodiment of the disclosure, an operation of the Tsi_delivery_request and an operation of T1 configured as the onDemandSIB-RequestProhibitTimer may be associated with each other in the relay, as follows. When the relay desires to transmit the DedicatedSIBRequest message with requested-SIB-List to the base station, it should not transmit the DecicatedSIBRequest message with requested-SIB-List in case that T1 is operating. Thus, while T1 is operating, the relay does not separately transmit the DedicatedSIBRequest message with requested-SIB-List for the system information message that should be requested to the base station in response to a request of the remote UE. In this case, the Tsi_delivery_request may be configured to be started when T1 starts, and stopped when T1 is stopped. When T1 is stopped, the relay may construct the DecicatedSIBRequest message with requested-SIB-List for transmitting, to the base station, necessary system information among the system information request messages collected from the remote UE before the Tsi_delivery_request is stopped, transmit the list to the base station, configure T1 as the onDemandSIB-RequestProhibitTimer, and start T1 (for example, when T1 starts, the Tsi_delivery_request may be set to the value (onDemandSIB-RequestProhibitTimer) of T1 and started, and when T1 is stopped, the Tsi_deliveryRequest may also be stopped).

(2) In an embodiment of the disclosure, while the relay constructs the DedicatedSIBRequest message with requested-SIB-List to request the system information message required for the relay, the Tsi_delivery_request may be started. The relay may determine the system information of the remote UE that can be included for request in its own DecicatedSIBRequest message with requested-SIB-List among the system information request messages of the remote UE collected before the Tsi_delivery_Request expires, and construct the requested-SIB-List. For example, among the system information messages requested by the remote UE, included in the system information message request of the relay may be when the remote UE requests a system information message that the relay has not yet acquired. The relay may configure T1 as the onDemandSIB-RequestProhibitTimer and start T1 while transmitting the list to the base station.

As described above, the relay may process the system information message request of the remote UE by applying the configured timers, and in another embodiment of the disclosure, the relay may operate the Tsi_delivery_request differently depending on its RRC state. For example, because the onDemandSIB-RequestProhibitTimer configured in T1 of the relay is operated when the relay is in the RRC_CONNECTED state, the operation of the Tsi_delivery_request associated with T1 may be used in the RRC_CONNECTED relay. When the relay is in the RRC_IDLE state or the RRC_INACTIVE state, the relay may independently operate the Tsi_delivery_request regardless of T1.

When requesting the system information message of the remote UE, the relay may apply the configuration used when transmitting the on-demand SI request to the base station in the RRC_IDLE state or the RRC_INACTIVE state. For example, the relay may transmit the on-demand SI request of the relay including the system information message requested by the remote UE to the base station by applying the following parameters.

si-RequestPeriod: Periodicity of the SI-Request configuration in number of association periods

ra-AssociationPeriodIndex: Index of the association period in the si-RequestPeriod in which the UE can send the SI request for SI message(s) corresponding to this SI-RequestResources, using the preambles indicated by ra-PreambleStartlndex and RACH occasions indicated by ra-ssb-OccasionMaskIndex

ra-ssb-OccasionMaskIndex: defines PRACH occasion(s) associated with an SSB in which the MAC entity may transmit a Random Access Preamble

When the relay receives the system information message request from the remote UE, the relay may have already acquired from the base station one or more system information messages requested by the remote UE, or may have to transmit the system information message request to the base station because one or more system information messages requested by the remote UE have not been yet acquired from the base station. In this case, a method for the relay to transmit to the remote UE the system information message requested by the remote UE may include at least one or a combination of the followings.

(1) If there is an already acquired system information message and it is determined as the most recent version of a system information message, the relay may immediately transmit the system information message in response to the system information message request of the remote UE.

(2) The relay may request the base station for the system information message requested by the remote UE, acquire the system information message from the base station, and then transmit the system information message to the remote UE.

(3) In case of having already acquired a part of the system information message requested by the remote UE and having to acquiring the other part by requesting the base station, the relay may request and acquire the system information message from the base station and then transmit the acquired system information message to the remote UE together with the already acquired system information message.

In the above cases (1), (2), and (3), the relay may transmit one or a plurality of system information messages at once in a single message or in a plurality of divided messages to the remote UE depending on the sidelink resource state.

Upon receiving a request for a system information message from the remote UE, the relay may check the version of the system information message and voluntarily send the most recent version of the system information message to the remote UE without receiving an SI request for the same system information message from the remote UE. In an embodiment of the disclosure, the operation of the relay to voluntarily forward the system information message requested by the remote UE may be applied regardless of the RRC state of the remote UE. In another embodiment of the disclosure, the operation of the relay to voluntarily forward the system information message requested by the remote UE may be applied only when the remote UE is in the RRC_IDLE state or the RRC_INACTIVE state, and may not be applied when the remote UE is in the RRC_CONNECTED state. This corresponds to a case in which the remote UE in the RRC_CONNECTED state is configured to transmit the system information message request to the base station, and the base station is configured to transmit the system information message required by the remote UE (direct transmission of the base station or relay transmission through the relay), whereas the remote UE in the RRC_IDLE state or the RRC_INACTIVE state is configured to transmit the system information message request to the relay, and the relay is configured to transmit the system information message required by the remote UE. In another embodiment of the disclosure, the operation of the relay UE to voluntarily forward the system information message requested by the remote UE is not applied even when there is indication that the remote UE it is not interested in the system information message anymore.

In case that at least one Remote UE requests a system information message through the relay and acquires the system information message from the relay, the relay may transmit the system information message to the Remote UE whenever the system information message requested by the Remote UE is acquired. The UE may continuously monitor the sidelink connection with the relay until it requests the relay for a system information message and receives the system information message from the relay. Alternatively, scheduling for transmitting and receiving system information through the sidelink connection between the relay and at least one Remote UE may be configured, and the Remote UE may monitor the sidelink connection with the relay only in a system information monitoring period in accordance with the system information scheduling. Embodiments in which the Remote UE and the relay transmit/receive a system information message in accordance with the system information scheduling in the sidelink will be described with reference to FIGS. 9A and 9B. Embodiments of FIGS. 9A and 9B may be used when the UE and the relay transmit/receive a system information message even when there is no data to be transmitted/received through the sidelink connection.

The relay may transmit a sidelink SI delivery indication including system information message scheduling in the sidelink. The sidelink SI delivery indication may be transmitted in a sidelink broadcast scheme. For transmitting the sidelink SI delivery indication, a PC5 RRC signaling radio bearer may be separately configured between the relay and the Remote UE. The sidelink SI delivery indication may include 1-bit indication information indicating whether system information is transmitted through the PC5 RRC connection. The sidelink SI delivery indication may include a bitmap (a bit is set to correspond to each SI message and each bit value 0 or 1 indicates non-transmission or transmission of the SI message) indicating whether system information is transmitted through the PC5 RRC connection. In order to transmit and receive a system information message through the sidelink, a sidelink SI transmission cycle and an SI window may be configured. The relay may transmit an SI message in the SI window according to the sidelink SI transmission cycle. The UE may monitor the SI message in the SI window according to the sidelink SI transmission cycle. The SI message transmitted in the SI window according to the sidelink SI transmission cycle corresponds to the system information message requested by at least one Remote UE. A reception resource pool in which the Remote UE can monitor the sidelink SI may be configured. Based on the sidelink SI transmission cycle and the SI window, the Remote UE does not need to monitor the sidelink with the relay unnecessarily. The Remote UE may transmit, to the relay, indication information to monitor only the sidelink SI delivery indication and monitor only the system information message. Upon receiving the above indication information, the relay may transmit a confirmation message to the Remote UE. In another embodiment of the disclosure, upon receiving the above indication information, the relay may determine that the Remote UE will not perform sidelink data transmission/reception other than the sidelink system information.

FIG. 9A is a diagram illustrating a scheduling structure of transmitting and receiving a system information message in a sidelink according to an embodiment of the disclosure.

Referring to FIG. 9A, an SI window 901, 911 may be configured for each sidelink SI transmission cycle 900, 910. The SI window 901, 911 may contain at least one system information message 903, 913 that the relay transmits to at least one UE. FIG. 9A illustrates a case in which the system information message transmitted in the SI window at the sidelink SI transmission cycle includes at least one system information message requested by at least one UE. The relay may transmit at least one of sidelink control information (SCI) and the system information message in the SI window of the sidelink SI transmission cycle. The UE may monitor at least one of the SCI and the system information message in the SI window of the sidelink SI transmission cycle. Based on scheduling information of the system information message to be transmitted in the SI window of the sidelink SI transmission cycle, the UE may determine whether to monitor the system information message in the corresponding SI window. The scheduling information of the system information message to be transmitted in the SI window of the sidelink SI transmission cycle may be acquired from the SCI. In another embodiment of the disclosure, the scheduling information of the system information message to be transmitted in the SI window of the sidelink SI transmission cycle may be acquired in a PC5-RRC message separate from the system information message. When an interested and necessary system information message is transmitted in the SI window, the UE may monitor the SI window to acquire the system information message, and when an uninterested and unnecessary system information message is transmitted in the SI window, the UE may not monitor the SI window.

FIG. 9B is a diagram illustrating a scheduling structure of transmitting and receiving a system information message in a sidelink according to an embodiment of the disclosure.

Referring to FIG. 9B, an SI window 951, 961 may be configured for each sidelink SI transmission cycle 950, 960. The SI window 951, 961 may contain at least one system information message 953, 955, 957; 963, 965 that the relay transmits to at least one UE. FIG. 9B illustrates a case in which, when a system information message requested by at least one UE is not changed compared to a system information message previously transmitted to the UE by the relay, such a non-updated system information message is not transmitted in the sidelink connection. For example, if it is determined that an SI Z message transmitted in the SI window 951 of the sidelink transmission cycle 950 is not changed in the sidelink transmission cycle 960, the SI window 961 of the sidelink transmission cycle 960 may not contain the SI Z message. The relay may transmit at least one of sidelink control information (SCI) and the system information message in the SI window of the sidelink SI transmission cycle. The UE may monitor at least one of the SCI and the system information message in the SI window of the sidelink SI transmission cycle. The UE may determine, based on scheduling information of the system information message to be transmitted in the SI window of the sidelink SI transmission cycle, whether to monitor the system information message in the corresponding SI window. The above scheduling information may be acquired in the SCI. In another embodiment of the disclosure, the above scheduling information may be acquired in the PC5-RRC message separate from the system information message. When an interested and necessary system information message is transmitted in the SI window, the UE may monitor the SI window to acquire the system information message, and when an uninterested and unnecessary system information message is transmitted in the SI window, the UE may not monitor the SI window.

When the relay transmits the system information message to at least one UE in accordance with the schemes of FIGS. 9A and 9B, the relay may transmit sidelink control information (SCI) for system information message transmission, and the UE may monitor the SCI for the system information message. The SCI used to transmit the system information message in the sidelink may correspond to the SCI for general sidelink communication.

In another embodiment of the disclosure, when the relay transmits the system information message to at least one UE according to the method of FIGS. 9A to 9B, the relay may transmit the SCI for the system information message transmission, and the UE may monitor the SCI for the system information message. The SCI used to transmit the system information message in the sidelink may be defined for the purpose of the system information message. The SCI for system information message transmission in the sidelink may include at least one of a source identifier of the system information message, a destination identifier of the system information message, a cast type (unicast, groupcast, broadcast), system information message scheduling information, information about the transmitted system information message (at least one of a system information message index list and a system information message bitmap), and a transmission format of system information (MCS, HARQ retransmission configuration, HARQ feedback configuration, retransmission number, reservation period, etc.).

In case that a transmission or monitoring resource pool of the system information message is configured separately from a transmission or monitoring resource pool of general sidelink communication, the transmission and monitoring operation of the system information message between the relay and the UE may be performed in the separately configured transmission or monitoring resource pool of the system information message.

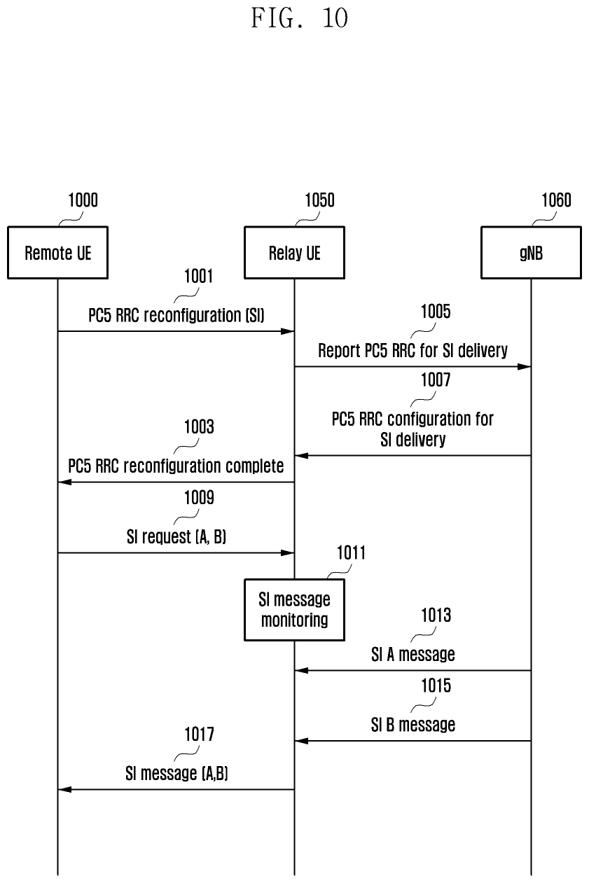

In case that the UE requests and receives the system information message through the relay, the UE and the relay may process the system information message request and the system information message transmission/reception through an already established PC5 RRC connection. In another embodiment of the disclosure, in case that the UE requests and receives the system information message through the relay, the PC5 RRC connection for the system information message between the UE and the relay may be established and released. An embodiment of establishing the PC5 RRC connection for the system information message will be described with reference to FIG. 10. This embodiment may be applied to a case in which data transmission and reception do not need to be performed through the sidelink RRC connection between the UE and the relay and the system information message transmission and reception is required.

FIG. 10 is a diagram illustrating a signal flow of establishing a PC5 RRC connection to acquire a system information message at a UE according to an embodiment of the disclosure.

Referring to FIG. 10, when determining that it is necessary to request and acquire a system information message through a relay (e.g., relay UE) 1050, at operation 1001, the UE (e.g., remote UE) 1000 may transmit to the relay UE 1050 a PC5 RRC reconfiguration (system information) for requesting the establishment of a PC5 RRC connection for the system information message. In case that the relay UE 1050 is in the RRC_CONNECTED state, the relay UE 1050 may transmit a message notifying a PC5 RRC connection establishment request for SI delivery to a base station (e.g., gNB) 1060 at operation 1005, and receive a response message including at least one of configuration information and resource allocation information required for PC5 RRC connection for SI delivery from the base station 1060 at operation 1007. Upon receiving the message notifying the PC5 RRC connection establishment request for SI delivery from the relay UE 1050, the base station 1060 may determine that there is no need to perform at least one of a data transmission/reception path setup procedure to a core network and a base station resource (data radio bearer) setup procedure for data transmission/reception for the UE, unlike general data, and may not perform such procedures. In case that the relay UE 1050 is in the RRC IDLE state or the RRC INACTIVE state, the relay UE 1050 may acquire configuration information necessary for establishing the PC5 RRC connection for SI delivery in a system information message transmitted by the base station 1060. At operation 1003, the relay UE 1050 may transmit a PC5 RRC reconfiguration complete (system information) to the Remote UE 1000 as a response to the PC5 RRC connection establishment request. If the PC5 RRC connection establishment request cannot be accepted, the relay UE 1050 may transmit a PC5 RRC reconfiguration failure (system information) to the Remote UE 1000. If there is more than one UE, the operations 1001 and 1003 may be performed between each UE and the relay UE 1050.

At operation 1009, the Remote UE 1000 may transmit a system information request message in the PC5 RRC connection configured for SI delivery. The system information request message of the operation 1009 may include information about at least one system information message necessary for the UE. The relay UE 1050 may acquire and collect system information request messages from at least one Remote UE 1000 and perform a necessary system information monitoring operation at operation 1011. At operations 1013 and 1015, the relay UE 1050 may monitor an SI A message, an SI B message, etc. from the base station 1060. If it is determined that there is a need to transmit to the Remote UE 1000 the system information message requested by the Remote UE 1000, at operation 1017, the relay UE 1050 may transmit the system information in the PC5 RRC connection for SI delivery established with the Remote UE 1000.

In case that the system information message is transmitted/received through the sidelink between the Remote UE and the relay in accordance with various embodiments of the disclosure, the system information message may be segmented and transmitted in the Uu link and may be segmented and transmitted in the sidelink. When the system information message is segmented and transmitted in the Uu link, the relay checks a value tag of each SI message and, if the value tag is identical with the value tag of a previously stored segment, stores the newly acquired segment. If the value tag is not identical with the value tag of the previously saved segment, the relay discards the previously stored segment and stores the newly acquired segment. In case of acquiring all segments of the SI message, the relay may assemble one SI message. In case of having to transmit to the Remote UE the SI segmented and assembled in the Uu, or in case of having to transmit to the Remote UE the SI transmitted without segmentation in the Uu, the relay may segment and transmit the SI based on the sidelink status. In case of having to receive the segmented SI transmitted in the sidelink, the Remote UE may check the value tag of each SI and store the newly acquired segment if the value tag is identical with the value tag of the previously stored segment. If the value tag is not identical with the value tag of the previously stored segment, the Remote UE may discard the previously stored segment and store the newly acquired segment. In case of acquiring all segments of the SI message, the Remote UE may assemble one SI message. If one SI message is not assembled within 3 hours, the UE discards the stored SI segment.

In case of the above-described relay transmission of the system information message according to various embodiments of the disclosure, if the base station does not transmit the system information message in a broadcast scheme, the relay or the Remote UE may transmit the system information request message to the base station. If the relay does not transmit the system information message in a broadcast scheme, the UE may transmit the system information request message to the relay. Or, if the relay does not transmit an essential system information message, the Remote UE may transmit the system information request message to the relay.

As described in the above example, system information, such as SIB12, SIB13, and SIB14 necessary for the Remote UE to perform sidelink communication, and system information (e.g., at least one of MIB, SIB1, SIB2, SIB3, SIB4, and SIB5) including cell selection/cell reselection information of the Remote UE may be required even when the Remote UE performs data transmission/reception with the base station through the relay. As such, in case of system information necessary for the Remote UE connected to the relay, it may be configured as system information essential to the Remote UE, and the system information essential to the Remote UE is not limited to the above embodiment (system information necessary for the UE to perform sidelink communication, and system information including cell selection/cell reselection information of the UE). As described above, the essential system information necessary for the Remote UE connected to the relay may include at least one of a system information message configured by the base station for the Remote UE to receive from the relay through the sidelink connection, a system information message configured by the base station for the Remote UE to request the relay through the sidelink connection, a system information message configured by the relay for the Remote UE to receive from the relay through the sidelink connection, and a system information message configured by the relay for the Remote UE to request the relay through the sidelink connection.

In case of the system information message configured for the Remote UE as essential system information, the relay may acquire the system information message from the base station and relay it to the Remote UE. The above system information message configured for the Remote UE as essential system information may be relayed in a broadcast (or groupcast) direct connection scheme to one or a large number of Remote UEs connected to the relay. The above system information message configured for the UE as essential system information may be relayed in a unicast (or groupcast) direct connection scheme in case that there is one or a small number of Remote UEs connected to the relay. If at least one of the above system information messages configured as essential system information is configured not to broadcast from the base station, the relay may transmit the system information request message for the system information message configured as essential system information to the base station and acquire it from the base station. The relay may relay to the Remote UE the system information message acquired from the base station. An embodiment of an operation that the relay requests and acquires the system information message from the base station and relays it to the Remote UE is the same as the embodiment of FIG. 7A. The system information request message transmitted to the base station for the system information message configured as essential system information may be included in the on-demand SI request that the relay UE transmits to the base station in the RRC_CONNECTED state. The system information request message transmitted to the base station for the system information message configured as essential system information may be included in the on-demand SI request that the relay UE transmits to the base station in the RRC_IDLE state or in the RRC_INACTIVE state.

In case of a system information message that is not configured as essential system information for the Remote UE connected to the relay, but needs to be acquired by the Remote UE, the Remote UE may monitor whether the system information message is relayed from the relay. If it is determined that the system information message is not relayed from the relay, the Remote UE may transmit a system information request message requesting the system information message to the relay. Alternatively, if a system information message is configured as essential system information for the Remote UE connected to the relay, and if the Remote UE can monitor whether the system information message is relayed from the relay and determines that the system information message is not relayed from the relay, the Remote UE may transmit a system information request message requesting the system information message to the relay. The relay may acquire the requested system information message by monitoring the system information message of the base station. If it is determined that the base station does not broadcast the system information message, the relay may transmit a system information request message requesting the system information message to the base station. The relay may acquire the system information message from the base station and relay it to the Remote UE. An embodiment of an operation that the relay receives the system information request message from the Remote UE, acquires the necessary system information message from the base station, and relays it to the UE, or an operation that the relay requests the base station to transmit the system information message requested by the Remote UE, acquires the requested system information message from the base station, and relays it to the Remote UE is the same as at least one of the embodiments of FIGS. 8A, 8B, and 8C. The system information request message transmitted to the base station for the system information message of the system information request message received from the Remote UE by the relay may be included in the on-demand SI request that the relay UE transmits to the base station in the RRC_CONNECTED state. The system information request message transmitted to the base station for the system information message of the system information request message received from the Remote UE by the relay may be included in the on-demand SI request that the relay UE transmits to the base station in the RRC_IDLE state or in the RRC_INACTIVE state.

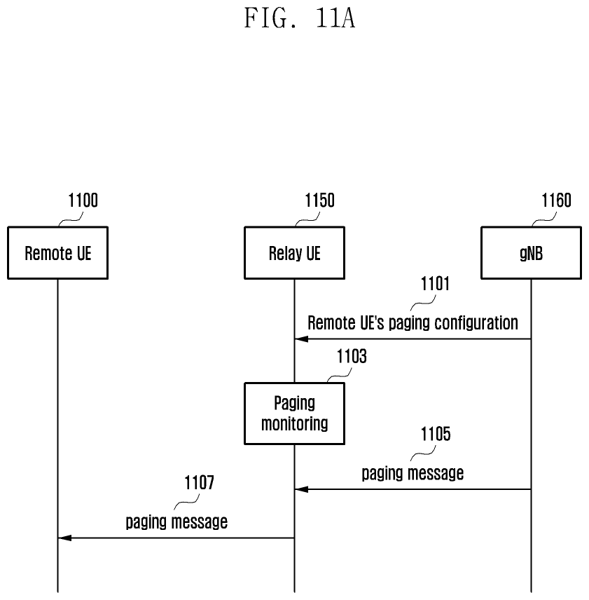

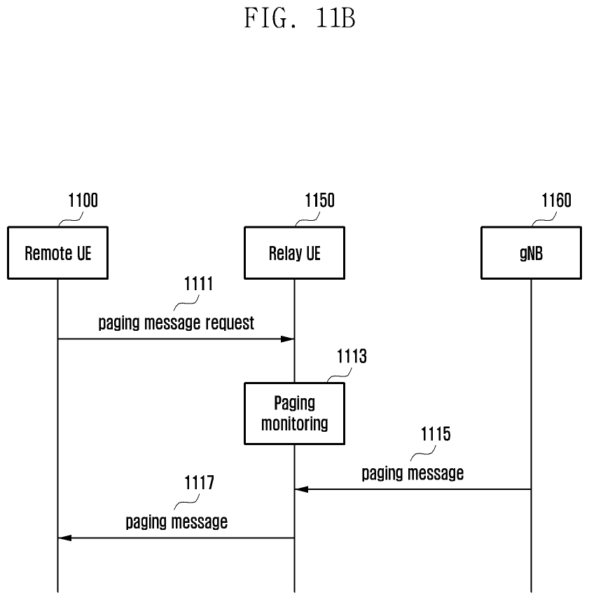

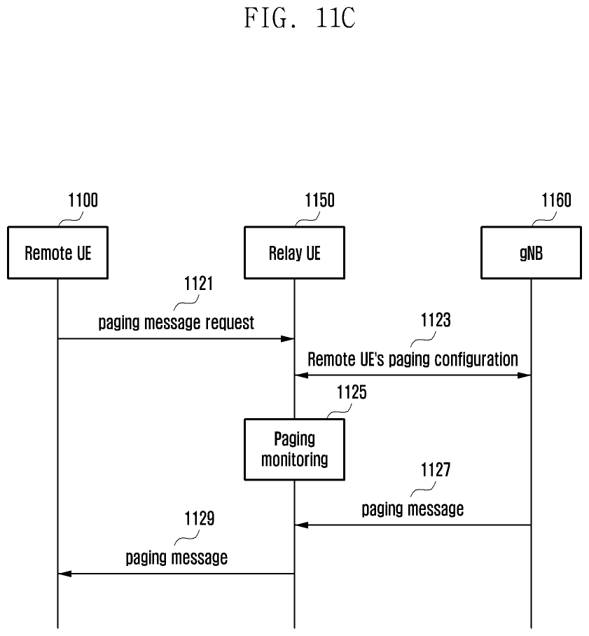

In case that the Remote UE is in the RRC_IDLE state or the RRC_INACTIVE state and is configured to receive through the relay a paging message transmitted by the base station, methods for the relay to transmit the paging message to at least one Remote UE will be described with reference to FIGS. 11A to 11C.

FIG. 11A is a diagram illustrating a signal flow of acquiring a paging message at a UE according to an embodiment of the disclosure.

Referring to FIG. 11A, when at least one Remote UE 1100 capable of performing data transmission and reception through a relay (e.g., relay UE) 1150 transitions to the RRC_INACTIVE state or the RRC_IDLE state, a base station (e.g., gNB) 1160 may determine to deliver through the relay 1150 a paging message that the Remote UE 1100 should monitor in the RRC_INACTIVE state or the RRC_IDLE state. At operation 1101, the base station 1160 may transmit, to the relay 1150, configuration information used for paging message monitoring of the Remote UE 1100. The relay 1150 may acquire, from the base station 1160, configuration information necessary for monitoring a paging message of at least one Remote UE 1100 that transitions to the RRC_INACTIVE state or the RRC_IDLE state. The configuration information used for the paging message monitoring of the operation 1101 may include at least one of a UE identifier in the RRC_INACTIVE state, a UE identifier in the RRC_IDLE state, a paging cycle, a paging offset, and a tracking area ID of the UE. In case that the relay 1150 transitions to the RRC_INACTIVE state or the RRC_IDLE state, the relay 1150 may acquire, from the base station 1160, configuration information (at least one of a paging cycle, a paging offset, a tracking area ID of the relay, a relay identifier in the RRC_INACTIVE state, and a relay identifier in the RRC_IDLE state) used for monitoring a paging message of the relay 1150 in addition to configuration information used for monitoring a paging message of the UE. At operation 1103, the relay 1150 may perform paging message monitoring. The operation 1103 includes an operation that the relay 1150 monitors the paging message of the Remote UE 1100. When the relay 1150 is in the RRC_IDLE state or the RRC_INACTIVE state, the relay 1150 may perform an operation of monitoring its own paging message and perform an operation of monitoring the paging message of at least one Remote UE 1100 being in the RRC_INACTIVE state or the RRC_IDLE state. At operation 1105, the relay 1150 may acquire a paging message transmitted from the base station 1160. The relay 1150 may process the paging message acquired at the operation 1105 to determine whether information (e.g., the identifier of the Remote UE 1100 in the RRC_IDLE state, the identifier of the Remote UE 1100 in the RRC_INACTIVE state) of the Remote UE 1100 to which the relay 1150 will deliver the paging message is contained. If information of the Remote UE 1100 is contained, the relay 1150 may transmit the paging message to the Remote UE 1100 through the sidelink at operation 1107. At the operation 1107, the relay 1150 transmits the paging message to at least one Remote UE 1100 indicated in the paging message of the operation 1105, and may transmit the paging message in a sidelink RRC connection (at least one of unicast, groupcast, and broadcast) with the corresponding Remote UE. In case that the relay 1150 is in the RRC_INACTIVE state or the RRC_IDLE state, the relay 1150 may process the paging message acquired at the operation 1105 to determine whether its own information (e.g., the identifier of the relay 1150 in the RRC_INACTIVE state, the identifier of the relay 1150 in the RRC_IDLE state) is contained, and if information of the relay 1150 is contained, the relay 1150 may perform an operation indicated in the paging message. The Remote UE 1100 being in the RRC_IDLE state or the RRC_INACTIVE state may receive the paging message transmitted by the relay 1150, determine whether its own information is contained, and if information of the Remote UE 1100 is contained, perform an operation indicated in the paging message.

FIG. 11B is a diagram illustrating a signal flow of acquiring a paging message at a Remote UE according to an embodiment of the disclosure.

Referring to FIG. 11B, in case that the Remote UE 1100 transitions to or is in the RRC_INACTIVE state or the RRC_IDLE state, at operation 1111, the Remote UE 1100 may transmit to the relay 1150 a sidelink message indicating a paging message request so as to request the relay 1150 to monitor, acquire, and transmit a paging message of the Remote UE 1100. The sidelink message of the operation 1111 may correspond to a PC5 unicast signaling message configured between the Remote UE 1100 and the relay 1150. The sidelink message of the operation 1111 may include at least one of a UE identifier in the RRC_INACTIVE state, a UE identifier in the RRC_IDLE state, a paging cycle, a paging offset, and a tracking area ID of the UE. Upon receiving the paging message transmission request message of the Remote UE 1100, the relay 1150 may determine whether to transmit the paging message, may or may not accept the paging message transmission request of the Remote UE 1100, and may transmit a response message to the Remote UE 1100. The Remote UE 1100 that transmits the paging message transmission request at the operation 1111 may be at least one Remote UE.

In case that the relay 1150 transitions to the RRC_INACTIVE state or the RRC_IDLE state, the relay 1150 may acquire, from the base station 1160, configuration information (at least one of a paging cycle, a paging offset, a tracking area ID of the relay, a relay identifier in the RRC_INACTIVE state, and a relay identifier in the RRC_IDLE state) used for monitoring a paging message of the relay 1150. At operation 1113, the relay 1150 may perform paging message monitoring. The operation 1113 includes an operation that the relay 1150 monitors the paging message of the Remote UE 1100. When the relay 1150 is in the RRC_IDLE state or the RRC_INACTIVE state, the relay 1150 may perform an operation of monitoring its own paging message and perform an operation of monitoring the paging message of at least one Remote UE 1100 being in the RRC_INACTIVE state or the RRC_IDLE state. At operation 1115, the relay 1150 may acquire a paging message transmitted from the base station 1160. The relay 1150 may process the paging message acquired at the operation 1115 to determine whether information (e.g., the identifier of the Remote UE 1100 in the RRC_IDLE state, the identifier of the Remote UE 1100 in the RRC_INACTIVE state) of the Remote UE 1100 to which the relay 1150 will deliver the paging message is contained. If information of the Remote UE 1100 is contained, the relay 1150 may transmit the paging message to the Remote UE 1100 through the sidelink at operation 1117. At the operation 1117, the relay 1150 transmits the paging message to at least one Remote UE 1100 indicated in the paging message of the operation 1115, and may transmit the paging message in a sidelink RRC connection (at least one of unicast, groupcast, and broadcast) with the corresponding UE. In case that the relay 1150 is in the RRC_INACTIVE state or the RRC_IDLE state, the relay 1150 may process the paging message acquired at the operation 1115 to determine whether its own information (e.g., the identifier of the relay 1150 in the RRC_INACTIVE state, the identifier of the relay 1150 in the RRC_IDLE state) is contained, and if information of the relay 1150 is contained, the relay 1150 may perform an operation indicated in the paging message. The Remote UE 1100 being in the RRC_IDLE state or the RRC_INACTIVE state may receive the paging message transmitted by the relay 1150, determine whether its own information is contained, and if information of the Remote UE 1100 is contained, perform an operation indicated in the paging message.

FIG. 11C is a diagram illustrating a signal flow of acquiring a paging message at a UE according to an embodiment of the disclosure.

Referring to FIG. 11C, in case that the Remote UE 1100 transitions to or is in the RRC_INACTIVE state or the RRC_IDLE state, at operation 1121, the Remote UE 1100 may transmit to the relay 1150 a sidelink message indicating a paging message request so as to request the relay 1150 to monitor, acquire, and transmit a paging message of the Remote UE 1100. The sidelink message of the operation 1121 may correspond to a PC5 unicast signaling message configured between the Remote UE 1100 and the relay 1150. The sidelink message of the operation 1121 may include at least one of a UE identifier in the RRC_INACTIVE state, a UE identifier in the RRC_IDLE state, a paging cycle, a paging offset, and a tracking area ID of the UE. The Remote UE 1100 that transmits the paging message transmission request at the operation 1121 may be at least one UE. At operation 1123, the relay 1150 may notify, to the base station 1160, information (e.g., a UE identifier in the RRC_INACTIVE state, a UE identifier in the RRC_IDLE state) of the UE requesting paging message transmission, and acquire, from the base station 1160, configuration information necessary for monitoring the paging message of at least one Remote UE 1100 being in the RRC_INACTIVE state or the RRC_IDLE state. The paging message monitoring configuration information of the Remote UE 1100 provided to the relay 1150 by the base station 1160 at the operation 1123 may include at least one of a UE identifier in the RRC_INACTIVE state, a UE identifier in the RRC_IDLE state, a paging cycle, a paging offset, and a tracking area ID of the UE. At the operation 1123, the base station 1160 may determine whether to accept the paging message transmission to at least one Remote UE 1100 that has requested the relay 1150 to transmit the paging message, and transmit information about paging message transmission acceptance or rejection to the Remote UE 1100 through the relay 1150. The paging message transmission acceptance or rejection may be transmitted to the at least one Remote UE 1100 by the relay 1150 as a response to the message of the operation 1121.

In case that the relay 1150 transitions to the RRC_INACTIVE state or the RRC_IDLE state, the relay 1150 may acquire, from the base station 1160, configuration information (at least one of a paging cycle, a paging offset, a tracking area ID of the relay, a relay identifier in the RRC_INACTIVE state, and a relay identifier in the RRC_IDLE state) used for monitoring a paging message of the relay 1150. At operation 1125, the relay 1150 may perform paging message monitoring. The operation 1125 includes an operation that the relay 1150 monitors the paging message of the Remote UE 1100. When the relay 1150 is in the RRC_IDLE state or the RRC_INACTIVE state, at the operation 1125, the relay 1150 may perform an operation of monitoring its own paging message and perform an operation of monitoring the paging message of at least one Remote UE 1100 being in the RRC_INACTIVE state or the RRC_IDLE state. At operation 1127, the relay 1150 may acquire a paging message transmitted from the base station 1160. The relay 1150 may process the paging message acquired at the operation 1127 to determine whether information (e.g., the identifier of the Remote UE 1100 in the RRC_IDLE state, the identifier of the Remote UE 1100 in the RRC_INACTIVE state) of the Remote UE 1100 to which the relay 1150 will deliver the paging message is contained. If information of the Remote UE 1100 is contained, the relay 1150 may transmit the paging message to the Remote UE 1100 through the sidelink at operation 1129. At the operation 1129, the relay 1150 transmits the paging message to at least one Remote UE 1100 indicated in the paging message of the operation 1127, and may transmit the paging message in a sidelink RRC connection (at least one of unicast, groupcast, and broadcast) with the corresponding UE. In case that the relay 1150 is in the RRC_INACTIVE state or the RRC_IDLE state, the relay 1150 may process the paging message acquired at the operation 1127 to determine whether its own information (e.g., the identifier of the relay UE 1150 in the RRC_INACTIVE state, the identifier of the relay 1100 in the RRC_IDLE state) is contained, and if information of the relay UE 1150 is contained, the relay 1150 may perform an operation indicated in the paging message. The Remote UE 1100 being in the RRC_IDLE state or the RRC_INACTIVE state may receive the paging message transmitted by the relay 1150, determine whether its own information is contained, and if information of the Remote UE 1100 is contained, perform an operation indicated in the paging message.

In case that the UE is in the RRC_INACTIVE state or the RRC_IDLE state, and the relay monitors the paging message of the corresponding UE and relays the paging message through the sidelink connection, the UE may also transmit a system information message request while transmitting a paging message transmission request message to the relay in the sidelink connection. In this case, in addition to paging message monitoring configuration information, information about a system information message (represented by at least one of SIB index list and SIB bitmap) requested by the UE may be included in the paging message transmission request message. Upon acquiring from the UE the paging message transmission request message including the system information message information in addition to the paging message monitoring configuration information, the relay may perform the paging message monitoring for the corresponding UE as shown in FIGS. 11A to 11C and the system information message monitoring as shown in FIGS. 8A to 8C, and also perform an operation of transmitting the paging message corresponding to the UE and the system information message requested by the UE through the sidelink connection.

In case that the relay transmits the system information message or the paging message to the UE through the sidelink, an HARQ retransmission may be performed, and information about the number of HARQ retransmissions may be set for each of the system information message and the page message. In case that the relay transmits the system information message or the paging message to the UE through the sidelink, HARQ retransmission based on HARQ ACK/NAK or HARQ NAK may be performed, and the HARQ retransmission based on HARQ ACK/NAK or HARQ NAK for the system information message or the paging message may be configured in the same way as in the case of transmitting and receiving general data or control messages through the sidelink and processed in the same manner by the relay and the UE. In case that the relay transmits the system information message or the paging message to the UE through the sidelink, an RLC layer ARQ may be configured, and it may be configured in the same way as in the case of transmitting and receiving general data or control messages through the sidelink and processed in the same manner by the relay and the UE. In case that the relay transmits the system information message or the paging message to the UE through the sidelink, at least one of integrity check application/non-application and ciphering application/non-application may be configured. When integrity check is applied or ciphering is applied, the integrity check setup and ciphering setup schemes used for transmitting and receiving general data or control messages through the sidelink may be processed in the same way for the system information request message, the system information message, and the paging message between the relay and the UE.

Various embodiments regarding the RRC state of the relay that relays the system information message or the paging message in the sidelink will be described.

In an embodiment of the disclosure, when the UE is configured to perform a relay role or determines to perform the relay role because a condition for performing the relay role is satisfied, the relay maintains the RRC_CONNECTED state. When the relay is configured not to perform the relay role any longer or determines not to perform the relay role because the condition for performing the relay role is not satisfied, for example, until the relay is released, the relay may maintain the RRC_CONNECTED state. In case of relaying traffic between at least one UE and the base station, the relay should maintain the RRC_CONNECTED state.

In an embodiment of the disclosure, when configured to perform the relay role or determining to perform the relay role because the condition for performing the relay role is satisfied, the relay may maintain at least one of the RRC_IDLE state, the RRC_INACTIVE state, or the RRC_CONNECTED state. In this case, the relay may not relay traffic between a certain UE and the base station. The relay that has performed a relay discovery and selection procedure and has established a sidelink RRC connection with at least one UE may transition to the RRC_CONNECTED state in order to relay traffic between the UE and the base station. The relay may maintain the RRC_CONNECTED state in order to deliver to the UE the system information message or the paging message transmitted by the base station. The relay may maintain the RRC_CONNECTED state when relaying traffic, the system information message, or the paging message between at least one UE and the base station. The relay may transition to the RRC_IDLE state or the RRC_INACTIVE state when it no longer relays traffic between the UE and the base station and does not relay the system information message or the paging message.

In an embodiment of the disclosure, when configured to perform the relay role or determining to perform the relay role because the condition for performing the relay role is satisfied, the relay may maintain at least one of the RRC_IDLE state, the RRC_INACTIVE state, or the RRC_CONNECTED state. In this case, the relay does not relay traffic between a certain UE and the base station and does not relay the system information message or the paging message. In case of performing a relay discovery procedure and a relay selection procedure and performing a PC5 RRC connection establishment procedure with at least one UE, the relay transitions to the RRC_CONNECTED state in order to relay traffic between the UE and the base station. If it is determined that the relay does not need to relay traffic between a certain UE and the base station, the relay may transition to the RRC_IDLE state or the RRC_INACTIVE state. While maintaining the RRC_IDLE state or the RRC_INACTIVE state, the relay may relay the system information message or the paging message between at least one UE and the base station. When the PC5 RRC connection establishment procedure is performed between the UE and the relay, at least one of a PC5 RRC SRB for normal SL communication, a PC5 RRC SRB for SI delivery, a relaying type (user traffic, SI/paging), and a UE's interest system information request message may be used as indication information for distinguishing between a PC5 RRC connection establishment for user traffic transmission/reception of UE and a PC5 RRC connection establishment for system information message/paging message.

When the UE selects or reselects the relay, at least one of the system information message and other relay selection conditions may be included as a condition considered by the UE. When the relay transmits a relay discovery message, SI message information (SI bitmap information or SIB index) supported by the cell which the relay is connected to or camps on may be included. The UE that receives the relay discovery message transmitted by the relay may consider at least one of the supported SI message information and other relay selection conditions in addition to signal strength when selecting or reselecting the relay.

In an embodiment of the disclosure, if there are two or more relays satisfying the signal strength condition when the UE receiving the relay discovery message transmitted by the relay selects or reselects the relay, the UE may select one relay by considering at least one of the supported SI message information and other relay selection conditions. For example, in case that there are relay 1 and relay 2 that satisfy the signal strength condition for relay selection, the relay discovery message transmitted by the relay 1 may contain information that SIB X and SIB Y can be supported, and the relay discovery message transmitted by the relay 2 may contain information that SIB X, SIB Y, and SIB Z can be supported. In this case, the UE may preferentially select the relay 2 capable of supporting SIB Z that the UE is interested in. When the UE requests and receives the system information message through the relay (the above embodiments of FIGS. 8A to 8C, FIGS. 9A and 9B, and FIG. 10), the UE may request, in the system information request message, some or all of the system information messages that the selected relay can support.

When the UE selects or reselects the relay, at least one of slice information and other relay selection conditions may be included as conditions considered by the UE. When the relay transmits the relay discovery message, the slice information supported by the cell which the relay is connected to or camps on may be included. The UE that receives the relay discovery message transmitted by the relay may consider at least one of the supported slice information and other relay selection conditions in addition to signal strength when selecting or reselecting the relay.

In an embodiment of the disclosure, if there are one or more relays satisfying the signal strength condition when the UE receiving the relay discovery message transmitted by the relay selects or reselects the relay, the UE may select one relay by considering at least one of the supported slice information and other relay selection conditions. For example, in case that there are relay 1 and relay 2 that satisfy the signal strength condition for relay selection, the relay discovery message transmitted by the relay 1 may contain information that slice A can be supported, and the relay discovery message transmitted by the relay 2 may contain information that slice B can be supported. In this case, the UE may preferentially select the relay 1 supporting slice A that the UE is interested in.

The methods according to claims or embodiments described in the disclosure may be implemented by hardware, software, or a combination of hardware and software.

In case of implementation using software, a computer-readable storage medium for storing one or more programs (software modules) may be provided as hardware. One or more programs stored in the computer-readable storage medium are configured for execution by one or more processors in an electronic device. The one or more programs include instructions that cause the electronic device to perform the methods according to claims or embodiments described herein.

Such programs (software module, software) may be stored in a random access memory, a non-volatile memory including a flash memory, a read only memory (ROM), an electrically erasable programmable ROM (EEPROM), a magnetic disc storage device, a compact disc ROM, digital versatile discs (DVDs) or other optical storage devices, and a magnetic cassette. Alternatively, the programs may be stored in a memory combining part or all of the above recording media. A plurality of memories may be equipped.

In addition, the programs may be stored in an attachable storage device accessible via a communication network formed of Internet, Intranet, local area network (LAN), wide area network (WAN), or storage area network (SAN) alone or in combination. This storage device may access an apparatus performing embodiments of the disclosure through an external port. In addition, a separate storage device in the communication network may access an apparatus performing embodiments of the disclosure.

In the above-described embodiments of the disclosure, components or elements have been expressed as a singular or plural form. It should be understood, however, that such singular or plural representations are selected appropriately according to situations presented for the convenience of description, and the disclosure is not limited to the singular or plural form. Even expressed in a singular form, a component or element may be construed as a plurality of components or elements, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

what is claimed is:

1. A method performed by a first terminal in a wireless communication system, the method comprising:
receiving, from a second terminal via a sidelink, a system information request message; and
transmitting, to the second terminal via the sidelink, a message including system information.

2. The method of claim 1, wherein the system information request message includes at least one system information block (SIB) type.

3. The method of claim 1, wherein the system information request message is a message transmitted in a PC5 radio resource control (RRC) unicast connection.

4. The method of claim 1, wherein the system information request message is indicated as at least one or a combination of a system information block (SIB) bitmap or a list of SIB indexes.

5. The method of claim 1, further comprising:
collecting a plurality of system information request messages in case that the first terminal receives the plurality of system information request messages.

6. A method performed by a second terminal in a wireless communication system, the method comprising:
transmitting, to a first terminal via a sidelink, a system information request message; and
receiving, from the first terminal via the sidelink, a message including system information.

7. The method of claim 6, wherein the system information request message includes at least one system information block (SIB) type.

8. The method of claim 6, wherein the system information request message is a message transmitted in a PC5 radio resource control (RRC) unicast connection.

9. The method of claim 6, wherein the system information request message is indicated as at least one or a combination of a system information block (SIB) bitmap or a list of SIB indexes.

10. The method of claim 6, wherein a plurality of system information request messages are collected in case that the first terminal receives the plurality of system information request messages.

11. A first terminal in a wireless communication system, the first terminal comprising:
a transceiver capable of transmitting and receiving at least one signal; and
at least one processor coupled to the transceiver,
wherein the at least one processor is configured to:
receive, from a second terminal via a sidelink, a system information request message, and
transmit, to the second terminal via the sidelink, a message including system information.

12. The first terminal of claim 11, wherein the system information request message includes at least one system information block (SIB) type.

13. The first terminal of claim 11, wherein the system information request message is a message transmitted in a PC5 radio resource control (RRC) unicast connection.

14. The first terminal of claim 11, wherein the system information request message is indicated as at least one or a combination of a system information block (SIB) bitmap or a list of SIB indexes.

15. The first terminal of claim 11, wherein the at least one processor is further configured to:
collect a plurality of system information request messages in case that the first terminal receives the plurality of system information request messages.

16. A second terminal in a wireless communication system, the second terminal comprising:
a transceiver capable of transmitting and receiving at least one signal; and
at least one processor coupled to the transceiver,
wherein the at least one processor is configured to:
transmit, to a first terminal via a sidelink, a system information request message, and
receive, from the first terminal via the sidelink, a message including system information.

17. The second terminal of claim 16, wherein the system information request message includes at least one system information block (SIB) type.

18. The second terminal of claim 16, wherein the system information request message is a message transmitted in a PC5 radio resource control (RRC) unicast connection.

19. The second terminal of claim 16, wherein the system information request message is indicated as at least one or a combination of a system information block (SIB) bitmap or a list of SIB indexes.

20. The second terminal of claim 16, wherein a plurality of system information request messages are collected in case that the first terminal receives the plurality of system information request messages.
